(19) United States
(12) Patent Application Publication
(10) Pub. No.: US 2025/0346485 A1
(43) Pub. Date: Nov. 13, 2025

(54) PHOTOCATALYTIC SPLITTING OF WATER

(71) Applicant: Oxford University Innovation Limited, Oxford (GB)

(72) Inventors: Yiyang LI, Oxford (GB); Shik Chi TSANG, Oxford (GB)

(21) Appl. No.: 18/580,185

(22) PCT Filed: Jul. 19, 2022
(86) PCT No.: PCT/GB2022/051864

§ 371 Date: Jan. 18, 2024

(30) Foreign Application Priority Data
Jul. 20, 2021 (GB) 2110427.8

(51) Int. Cl. C01B 3/04; B01J 21/06; B01J 27/051; B01J 35/39

(52) U.S. Cl. CPC C01B 3/042; B01J 21/063; B01J 27/0515; B01J 35/39; C01B 2203/0277; C01B 2203/107

(57) ABSTRACT

Photocatalytic water-splitting processes are described using an aqueous solution of at least one neutral salt, where the process is conducted at a temperature of 200-400° C. When compared with conventional photocatalytic water-splitting processes, the processes of the invention give rise to notably increased activity and quantum efficiency.

### CROSS-REFERENCE TO RELATED APPLICATIONS

This application is the National Stage of International Application No. PCT/GB2022/051864, filed Jul. 19, 2022, which claims priority to GB 2110427.8, filed Jul. 20, 2021, which are entirely incorporated herein by reference.

### INTRODUCTION

The present invention relates to a process for the photocatalytic splitting of water. More particularly, the present invention relates to a process for the photocatalytic splitting of water, said water forming part of an aqueous solution of at least one neutral salt, wherein the process is conducted at elevated temperature.

### BACKGROUND OF THE INVENTION

Storage of solar energy and conversion to chemical energy by photocatalytic processes have become a promising strategy to mitigate the energy crisis in recent years, which makes the photocatalytic overall water splitting (POWS) reaction attract increasing attention all around the world. With the help of proper photocatalysts, oxygen and hydrogen are produced from water stoichiometrically via POWS reaction and the solar energy is therefore stored in the form of hydrogen, which is an attractive carbon-emission-free chemical fuel with high energy density of 143 MJ kg^{-1 1-3}. Consequently, various solar-to-hydrogen (STH) conversion approaches have been developed, among which the particulate photocatalytic systems show great potential for scale-up, meanwhile, such powder-based systems require less complicated set-up and less capital cost compared with photovoltaic-electrolysis (PV-E) or photoelectrochemical (PEC) systems⁴. However, the STH efficiencies of currently reported POWS systems still fall far behind the application requirements due to the intrinsic slow generation but fast recombination of photo-generated charge carriers of the semiconductor materials used. Qian et al. developed a Z-scheme POWS system showing a STH efficiency of 1.1%⁵, and recent studies pushed the value to around 5%^{6,7}. Despite the great progress achieved so far, the STH of particulate POWS systems still fails to meet the goal of 10% proposed by the United States Department of Energy⁸. Some novel strategies to harvest the solar energy more efficiently are therefore urgently required.

The present invention was devised with the foregoing in mind.

### SUMMARY OF THE INVENTION

According to a first aspect of the present invention there is provided a process for the photocatalytic splitting of water, the process comprising the step of:
a) contacting a photocatalyst with an aqueous solution of at least one neutral salt;
wherein step a) is conducted under the application of light having a wavelength of 350-1000 nm and at a temperature of 200-400° C.

Particularly suitably, the aqueous solution of at least one neutral salt is naturally occurring, such as seawater or salt lake water.

### DETAILED DESCRIPTION OF THE INVENTION

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (wt. % or % w/w), said weight percentage refers to the percentage of said component by weight relative to the total weight of the product as a whole. It will be understood by those skilled in the art that the sum of weight percentages of all components of a product will total 100 wt. %. However, where not all components are listed (e.g. where a product is said to “comprise” one or more particular components), the weight percentage balance may optionally be made up to 100 wt % by unspecified ingredients.

### Photocatalytic Water Splitting Process

As described hereinbefore, in one aspect the invention provides a process for the photocatalytic splitting of water, the process comprising the step of:
a) contacting a photocatalyst with an aqueous solution of at least one neutral salt;
wherein step a) is conducted under the application of light having a wavelength of 350-1000 nm and at a temperature of 200-400° C.

Until recently, most POWS studies have focused on achieving wider range of light absorption of the catalysts. However, it has now been recognised that a broadened absorption range would not necessarily lead to improved performance. Instead, for reactions like POWS which involve multiple electrons and holes in the redox reactions, the photo-generated charge carriers must have sufficient lifetimes to travel to the surface and accumulate at active centres to allow the POWS chemical reactions to take place. The inventors have determined that facilitating the separation of charge carriers is more important in this system, such that the photo-generated electrons and holes can participate in surface reactions instead of recombining to generate heat. Through rigorous investigations, the inventors have now surprisingly determined that such separation of charge carriers can be readily accomplished, and hence the overall catalytic activity dramatically increased, by conducting the POWS reaction in the presence of one or more neutral salts (e.g. NaCl) at elevated temperature (i.e. 200-400° C.).

The inventors have shown that carrying out the POWS reaction in the presence of one or more neutral salts cause ionic species to be absorbed on the surface of the photocatalyst, which introduces a strong local electric field that facilitates the separation of the photogenerated charge carriers and significantly enhances catalytic activity. The inventors have demonstrated that such significant increases in catalytic activity can be achieved using simple neutral salt solutions at elevated temperature (e.g. a solution of NaCl) as well as more complex solutions at elevated temperature, notably seawater. The global abundance of seawater and other bodies of saline water (e.g. salt water lakes) underlines the industrial and environmental advantages of the invention.

It will be understood that an aqueous solution of at least one neutral salt refers to water comprising the at least neutral salt as a solute. Neutral salts will be familiar to one of ordinary skill in the art as those formed from the reaction of a strong acid with a strong base, such that the resulting salt does not hydrolyse in water to produce H₃O⁺ or OH⁻. Strong acids include those having a pKₐ lower than −2.5. Strong bases include alkali metal hydroxides and alkali earth metal hydroxides.

In particularly suitable embodiments, the at least one neutral salt is an inorganic neutral salt. More suitably, the at least one neutral salt is selected from the group consisting of NaCl, MgCl₂, CaCl₂, NaSO₄ and Na₃PO₄. Even more suitably, the at least one neutral salt is selected from the group consisting of NaCl and CaCl₂. Most suitably, the at least one neutral salt is NaCl. The salinity of seawater and other natural bodies of saline water is primarily due to NaCl.

Particularly suitably, the aqueous solution of the at least one neutral salt has a pH of 6-9.

The inventors have shown that even small quantities of neutral salts, which will affect the overall ionic strength of the aqueous solution, can have a beneficial effect on the catalytic activity. Thus, the aqueous solution may have an ionic strength of ≥0.005 mol L⁻¹. The inventors have, however, demonstrated that the catalytic activity increases as the concentration of the neutral salt(s) within the aqueous solution, and hence the overall ionic strength of the aqueous solution, increases. Therefore, the ionic strength of the aqueous solution is suitably ≥0.01 mol L⁻¹. More suitably, the ionic strength of the aqueous solution is ≥0.1 mol L⁻¹. Even more suitably, the ionic strength of the aqueous solution is ≥0.5 mol L⁻¹. Seawater typically has an ionic strength of 0.65-0.70 mol L⁻¹.

The catalytic activity can be increased even further by increasing the ionic strength beyond that typically observed for seawater. Thus, the aqueous solution may have an ionic strength of ≥1.0 mol L⁻¹. More suitably, the aqueous solution may have an ionic strength of ≥2.5 mol L⁻¹. Even more suitably, the aqueous solution may have an ionic strength of ≥5.0 mol L⁻¹. Bodies of saline water such as the Great Salt Lake, the Aral Sea, Lop Nor and the Dead Sea have ionic strengths ranging from 4.0-7.0 mol L⁻¹. The catalytic activity may continue to increase as the ionic strength for the aqueous solution increases ever further. Nevertheless, in certain embodiments, the aqueous solution may have an ionic strength of ≤10.0 mol L⁻¹.

The salinity of the aqueous solution can also be expressed relative to the concentration of the at least one neutral salt. It will be understood that the concentrations discussed herein refer to the amount of the neutral salt (e.g. NaCl) present in the aqueous solution, rather than the amount of particular solutes (e.g. Na⁺ or Cl⁻) present therein. The concentration of the at least one neutral salt (e.g. NaCl) within the aqueous solution may be ≥0.005 mol L⁻¹. Suitably, the concentration of the at least one neutral salt within the aqueous solution is ≥0.01 mol L⁻¹. More suitably, the concentration of the at least one neutral salt within the aqueous solution is ≥0.1 mol L⁻¹. Even more suitably, the concentration of the at least one neutral salt within the aqueous solution is ≥0.5 mol L⁻¹. Yet even more suitably, the concentration of the at least one neutral salt within the aqueous solution is ≥1.0 mol L⁻¹. Yet still more suitably, the concentration of the at least one neutral salt within the aqueous solution is ≥2.5 mol L⁻¹. Yet still even more suitably, the concentration of the at least one neutral salt within the aqueous solution is ≥5.0 mol L⁻¹. Since the salinity of seawater and other natural bodies of saline water (such as the Great Salt Lake, the Aral Sea, Lop Nor and the Dead Sea) is primarily due to NaCl, the at least one neutral salt is suitably NaCl.

In particularly suitable embodiments, the aqueous solution of at least one neutral salt is naturally-occurring. Naturally-occurring bodies of saline waters include seawater and salt lake water. In the context of this document, naturally-occurring saline water includes that whose salinity has been increased, e.g. by evaporation or distillation, or decreased, e.g. by dilution. Naturally-occurring saline waters typically include at least the following: chloride, sodium, sulfate, magnesium, calcium, potassium and bromide.

Step a) involves bringing the aqueous solution of the at least one neutral salt into contact with the photocatalyst, this being conducted in the presence of light having a wavelength of 350-1000 nm. Irradiating the photocatalyst with electromagnetic radiation of this wavelength (which includes visible light and light in the near IR region) initiates the POWS reaction. The light having a wavelength of 350-1000 nm may be provided by a natural light source (e.g. solar energy), a simulated solar light source, a Xenon arc lamp, a tungsten lamp or a halogen lamp. Particularly suitably, the light having a wavelength of 350-1000 nm in step a) is provided as solar energy.

Step a) is conducted at a temperature of 200-400° C. The inventors have demonstrated that the POWS reaction proceeds slowly under ambient conditions, limited by the slow Vₒ regeneration process, whilst elevating the temperature to between 200 and 400° C. leads to the regeneration of the Vₒ and results in increased catalytic activity. Suitably, step a) is conducted at a temperature of 220-350° C. More suitably, step a) is conducted at a temperature of 240-300° C. Most suitably, step a) is conducted at a temperature of 250-290° C. (e.g., 255-285° C.). It is particularly suitable that solar energy is used to heat the aqueous solution and the photocatalyst to 200-400° C.

In particularly suitable embodiments, solar energy is used as both a light source (i.e. for the light having a wavelength of 350-1000 nm) and a heat source (i.e. to carry out step a) at a temperature of 200-400° C.). The use of a solar concentrator is particularly useful in such embodiments.

The process is suitably conducted in a closed system (e.g. a sealed vessel), suitably at equilibrium pressure.

Any photocatalyst may be used in connection with the presently described process. Indeed, the inventors have shown that the increase in catalytic activity observed when the POWS reaction is conducted in the presence of at least one neutral salt (e.g., in seawater or salt lake water) at elevated temperature is not limited to any one photocatalyst in particular. On the contrary, the inventors have demonstrated that the process is applicable to a variety of photocatalysts having diverse structures and compositions. Non-limiting examples of suitable photocatalysts include metal oxide photocatalysts, 2-dimensional transition metal dichalcogenide photocatalysts, oxynitride perovskite photocatalysts and metal nitride photocatalysts.

The photocatalyst may comprise 0.05-5.0 wt. % of a transition metal reduction co-catalyst. Suitably, the photocatalyst comprises 0.1-4.0 wt. % of a transition metal reduction co-catalyst. More suitably, the photocatalyst comprises 0.5-3.0 wt. % of a transition metal reduction co-catalyst.

The transition metal reduction co-catalyst may be selected from the group consisting of Au, Ag, Ni, Pd, Pt, Co, Ir, Ru, Rh, Tc, Re, and Os

In certain embodiments, the photocatalyst is a metal oxide photocatalyst comprising a metal oxide selected from titanium dioxide, tantalum pentoxide and zinc oxide, wherein the metal oxide photocatalyst optionally comprises 0.05-5.0 wt. % of at least one transition metal reduction co-catalyst. Suitably, the photocatalyst is a nitrogen-doped metal oxide photocatalyst, wherein the nitrogen-doped metal oxide photocatalyst optionally comprises 0.05-5.0 wt. % of at least one transition metal reduction co-catalyst. More suitably, the photocatalyst is a nitrogen-doped titanium dioxide photocatalyst, wherein the nitrogen-doped titanium dioxide photocatalyst optionally comprises 0.05-5.0 wt. % of at least one transition metal reduction co-catalyst. In such embodiments, the at least one transition metal reduction co-catalyst is suitably Au. The nitrogen-doped metal oxide photocatalyst (e.g., nitrogen-doped titanium dioxide) may comprise 0.5-10 wt. % nitrogen. Suitably, the nitrogen-doped metal oxide photocatalyst comprises 1.0-8.0 wt. % nitrogen (e.g., 2.5-7.5 wt. % nitrogen).

In certain embodiments, the photocatalyst is a 2-dimensional transition metal dichalcogenide photocatalyst of the formula MX₂, where M is Mo or W and X is S, Se or Te, optionally wherein the 2-dimensional transition metal dichalcogenide photocatalyst comprises 0.05-5.0 wt. % of at least one transition metal reduction co-catalyst. In such embodiments, the 2-dimensional transition metal dichalcogenide suitably has a thickness of 0.4-0.9 nm (e.g. monolayer MX₂) and/or the at least one transition metal reduction co-catalyst is suitably Ru.

In certain embodiments, the photocatalyst is an oxynitride perovskite photocatalyst optionally wherein the oxynitride perovskite photocatalyst comprises 0.05-5.0 wt. % of at least one transition metal reduction co-catalyst. Oxynitride perovskites will be understood to have the structural formula AB(O,N)₃ (e.g., where A is Ca, Sr or Ba and B is Nb or Ta). Suitably, the oxynitride perovskite photocatalyst is selected from BaTaO₂N and CaTaO₂N. The oxynitride perovskite photocatalyst may be a lanthanide-doped oxynitride perovskite photocatalyst (e.g. lanthanide-doped BaTaO₂N). It will be understood that the lanthanide occupies a quantity of the A sites of the oxynitride perovskite. The lanthanide may be selected from the group consisting of La, Ce, Pr, Nd, Sm, Eu, Gd, Tb, Ho, Tm, Yb and Lu. Suitably, the lanthanide is selected from Nd, Sm, Eu, Gd, Tb and Ho. Most suitably, the lanthanide is Gd (e.g., the photocatalyst is Gd-doped BaTaO₂N). For example, the photocatalyst may have the formula LnₓBa₁₋ₓTa(O,N)₃, where Ln denotes a lanthanide and x is 0.05-0.45. Suitably, x is 0.1, 0.2 or 0.4, each ±0.2. Suitably, Ln is Gd.

In certain embodiments, the photocatalyst is a metal nitride photocatalyst being Ta₃N₅.

In a particularly suitable embodiment, the photocatalyst is i) a nitrogen-doped titanium dioxide photocatalyst comprising 0.05-5.0 wt. % of at least one transition metal reduction co-catalyst, wherein the at least one transition metal reduction co-catalyst is Au; or ii) a 2-dimensional transition metal dichalcogenide photocatalyst that is MoS₂ having a thickness of 0.4-0.9 nm (e.g. a MoS₂ monolayer) and comprising 0.05-5.0 wt. % of at least one transition metal reduction co-catalyst, wherein the at least one transition metal reduction co-catalyst is Ru.

In certain embodiments, the photocatalyst is a nitrogen-doped metal oxide photocatalyst (e.g., nitrogen-doped titanium dioxide), a 2-dimensional transition metal dichalcogenide photocatalyst, an oxynitride perovskite photocatalyst or a metal nitride photocatalyst. Each type of photocatalyst may be as further described hereinbefore.

The photocatalyst may be supported on a polar-faceted metal oxide support. Metal oxides may exist in solid states wherein the solid surfaces can be non-polar (dipole-less) or polar (possessing a dipole). For example, the (111) facet of MgO is polar as it comprises positively charged Mg-terminated facets and negatively charged O-terminated facets. The non-polar MgO (110) and (100) facets, on the other hand, have net neutral charges. Therefore, although they have equivalent structures, polar faceted metal oxides have a higher surface energy than the corresponding non-polar faceted metal oxides. It is postulated that the higher surface energy of polar faceted metal oxides makes them more favourable for oxygen vacancy formation, and have been found to surprisingly boost the photocatalytic performance. Suitably, the metal oxide is selected from CeO₂ having exposed (100) polar facets, MgO having exposed (111) polar facets, ZnO having exposed (0001) polar facets, or a mixture thereof. More suitably, the aforementioned polar facets form at least 25%, preferably 50%, more preferably 75%, of the exposed surfaces of the metal oxide. The quantity of such facets can be determined, for example, by integration of the characteristic peaks in nuclear magnetic resonance.

When the photocatalyst is supported on a polar-faceted metal oxide support, the wt:wt ratio of the photocatalyst to polar faceted metal oxide support is within the range 25:75 to 75:25. Suitably, the wt:wt ratio of the photocatalyst to polar faceted metal oxide support is within the range 35:65 to 65:35. More suitably, the wt:wt ratio of the photocatalyst to polar faceted metal oxide support is within the range 45:55 to 55:45.

In certain embodiments, the photocatalyst further comprises magnetic particles (e.g. magnetic nanoparticles) and step a) is carried out under application of an external magnetic field. The inventors have surprisingly determined that by modifying the photocatalyst so as to include magnetic particles (e.g. paramagnetic particles or superparamagnetic particles) and applying an external magnetic field during step a), the strong local induced magnetic field leads to increased catalytic activity. The photocatalyst may comprise 1-50 wt % of the magnetic particles. Suitably, the photocatalyst comprises 5-45 wt % of the magnetic particles.

The magnetic particles are suitably magnetic nanoparticles, more suitably paramagnetic or superparamagnetic nanoparticles. Nanoparticles will be understood to denote particles having a mean particle size of 1-100 nm as determined by transmission electron microscope (TEM). Particularly suitable magnetic particles include superparamagnetic Fe₃O₄ nanoparticles having a mean particle size of 2-20 nm.

The magnetic particles may be coated, either partly or wholly. The coating is suitably silica.

The strength of the external magnetic field may be 0.001-1.0 Tesla.

Step a) may be conducted in the presence of an infrared (IR) radiation-absorbing material (e.g., Cs_{0.33}WO₃). The inclusion of an IR absorbing-material gives rise to additional photothermal conversion.

The photocatalyst may be provided in a variety of different forms, including as a powder, particles, pellets, a film or as a fixed bed.

Superheated steam generated during the process may be injected into a steam turbine to generate electric energy, thereby rendering the process more energy efficient. This is particularly suitable where solar energy is used as the source of light and heat. Electricity generated by this means may be used in the electrolysis of water, meaning that heat stored in steam can contribute to additional H₂ evolution.

According to a further aspect of the invention, there is provided a photocatalyst described herein.

The following numbered statements 1 to 60 are not claims, but instead describe particular aspects and embodiments of the invention:
1. A process for the photocatalytic splitting of water, the process comprising the step of:
   a) contacting a photocatalyst with an aqueous solution of at least one neutral salt; wherein step a) is conducted under the application of light having a wavelength of 350-1000 nm and at a temperature of 200-400° C.
2. The process of statement 1, wherein the aqueous solution of the at least one neutral salt has an ionic strength of ≥0.005 mol L⁻¹.
3. The process of statement 1, wherein the aqueous solution of the at least one neutral salt has an ionic strength of ≥0.01 mol L⁻¹.
4. The process of statement 1, wherein the aqueous solution of the at least one neutral salt has an ionic strength of ≥0.1 mol L⁻¹.
5. The process of statement 1, wherein the aqueous solution of the at least one neutral salt has an ionic strength of ≥0.5 mol L⁻¹.
6. The process of statement 1, wherein the aqueous solution of the at least one neutral salt has an ionic strength of ≥1.0 mol L⁻¹.
7. The process of statement 1, wherein the aqueous solution of the at least one neutral salt has an ionic strength of ≥2.5 mol L⁻¹.
8. The process of statement 1, wherein the aqueous solution of the at least one neutral salt has an ionic strength of ≥5.0 mol L⁻¹.
9. The process of any one of the preceding statements, wherein the concentration of the at least one neutral salt within the aqueous solution is ≥0.005 mol L⁻¹.
10. The process of any one of the preceding statements, wherein the concentration of the at least one neutral salt within the aqueous solution is ≥0.01 mol L⁻¹.
11. The process of any one of the preceding statements, wherein the concentration of the at least one neutral salt within the aqueous solution is ≥0.1 mol L⁻¹
12. The process of any one of the preceding statements, wherein the concentration of the at least one neutral salt within the aqueous solution is ≥0.5 mol L⁻¹.
13. The process of any one of the preceding statements, wherein the concentration of the at least one neutral salt within the aqueous solution is ≥1.0 mol L⁻¹.
14. The process of any one of the preceding statements, wherein the concentration of the at least one neutral salt within the aqueous solution is ≥2.5 mol L⁻¹.
15. The process of any one of the preceding statements, wherein the concentration of the at least one neutral salt within the aqueous solution is ≥5.0 mol L⁻¹.
16. The process of any one of the preceding statements, wherein the at least one neutral salt is an inorganic salt.
17. The process of any one of the preceding statements, wherein the at least one neutral salt is selected from the group consisting of NaCl, MgCl₂, CaCl₂, NaSO₄ and Na₃PO₄.
18. The process of statement 17, wherein the at least one neutral salt is NaCl.
19. The process of any one of the preceding statements, wherein the aqueous solution of the at least one neutral salt is naturally occurring.
20. The process of any one of the preceding statements, wherein the aqueous solution of the at least one neutral salt is seawater or salt lake water.
21. The process of any one of the preceding statements, wherein the aqueous solution of the at least one neutral salt has a pH of 6-9.
22. The process of any one of the preceding statements, wherein the photocatalyst is a metal oxide photocatalyst, a 2-dimensional transition metal dichalcogenide photocatalyst, an oxynitride perovskite photocatalyst or a metal nitride photocatalyst.
23. The process of statement 22, wherein the photocatalyst is a metal oxide photocatalyst comprising a metal oxide selected from titanium dioxide, tantalum pentoxide and zinc oxide, wherein the metal oxide photocatalyst optionally comprises 0.05-5.0 wt. % of at least one transition metal reduction co-catalyst.
24. The process of statement 22 or 23, wherein the metal oxide photocatalyst is a nitrogen-doped metal oxide photocatalyst.
25. The process of statement 22, 23 or 24, wherein the photocatalyst is a nitrogen-doped titanium dioxide photocatalyst, wherein the nitrogen-doped titanium dioxide photocatalyst optionally comprises 0.05-5.0 wt. % of at least one transition metal reduction co-catalyst.
26. The process of statement 22, wherein the photocatalyst is a 2-dimensional transition metal dichalcogenide photocatalyst of the formula MX₂, where M is Mo or W and X is S, Se or Te, optionally wherein the 2-dimensional transition metal dichalcogenide photocatalyst comprises 0.05-5.0 wt. % of at least one transition metal reduction co-catalyst.
27. The process of any one of statements 23 to 26, wherein the transition metal reduction co-catalyst is selected from the group consisting of Au, Ag, Ni, Pd, Pt, Co, Ir, Ru, Rh, Tc, Re, and Os.
28. The process of statement 25, wherein the photocatalyst is a nitrogen-doped titanium dioxide photocatalyst comprising 0.05-5.0 wt. % of at least one transition metal reduction co-catalyst, wherein the at least one transition metal reduction co-catalyst is Au.
29. The process of statement 24, 25 or 28, wherein the nitrogen-doped metal oxide photocatalyst comprises 0.5-10 wt. % nitrogen.
30. The process of statement 29, wherein nitrogen-doped metal oxide photocatalyst comprises 1.0-8.0 wt. % nitrogen.
31. The process of statement 29, wherein nitrogen-doped metal oxide photocatalyst comprises 2.5-7.5 wt. % nitrogen.
32. The process of statement 26, wherein the photocatalyst is a 2-dimensional transition metal dichalcogenide photocatalyst that is single layer MoS₂, comprising 0.05-5.0 wt. % of at least one transition metal reduction co-catalyst, wherein the at least one transition metal reduction co-catalyst is Ru.
33. The process of statement 22, wherein the photocatalyst is an oxynitride perovskite photocatalyst optionally wherein the oxynitride perovskite photocatalyst comprises 0.05-5.0 wt. % of at least one transition metal reduction co-catalyst.
34. The process of statement 33, wherein the oxynitride perovskite photocatalyst is selected from BaTaO₂N and CaTaO₂N.
35. The process of statement 33 or 34, wherein the oxynitride perovskite photocatalyst is a lanthanide-doped oxynitride perovskite photocatalyst.
36. The process of statement 35, wherein the lanthanide is selected from Nd, Sm, Eu, Gd, Tb and Ho.
37. The process of statement 35, wherein the lanthanide is Gd (e.g., the photocatalyst is Gd-doped BaTaO₂N).
38. The process of statement 35, 36 or 37, wherein the photocatalyst has the formula LnₓBa₁₋ₓTa(O,N)₃, where Ln denotes a lanthanide (e.g., Gd) and x is 0.05-0.45.
39. The process of statement 38, wherein x is 0.1, 0.2 or 0.4, each ±0.2.
40. The process of statement 22, wherein the photocatalyst is a metal nitride photocatalyst being Ta₃N₅.
41. The process of any one of statements 1 to 21, wherein the photocatalyst is a nitrogen-doped metal oxide photocatalyst (e.g., nitrogen-doped titanium dioxide), a 2-dimensional transition metal dichalcogenide photocatalyst, an oxynitride perovskite photocatalyst or a metal nitride photocatalyst, any one of which may be as further defined in any one of statements 23 to 40.
42. The process of any one of the preceding statements, wherein the photocatalyst is supported on a polar-faceted metal oxide support.
43. The process of statement 42, wherein the metal oxide is selected from CeO₂ having exposed (100) polar facets, MgO having exposed (111) polar facets, ZnO having exposed (0001) polar facets, or a mixture thereof.
44. The process of statement 42 or 43, wherein the exposed polar facets form at least 25% of all exposed surfaces of the metal oxide.
45. The process of any one of the preceding statements, wherein step a) is conducted at a temperature of 220-350° C.
46. The process of any one of the preceding statements, wherein step a) is conducted at a temperature of 240-300° C.
47. The process of any one of the preceding statements, wherein step a) is conducted at a temperature of 250-290° C. (e.g., 255-285° C.).
48. The process according to any one of the preceding statements, wherein the light having a wavelength of 350-1000 nm in step a) is provided as solar energy.
49. The process according to any one of statements 1 to 47, wherein the light having a wavelength of 350-1000 nm is provided by a simulated solar light source, a Xe arc lamp, a tungsten lamp or a halogen lamp.
50. The process according to any one of statements 1 to 48, wherein solar energy is used as both a light source and a heat source during step a).
51. The process of statement 50, wherein solar energy is concentered using a solar concentrator during step a).
52. The process of any one of the preceding statements, wherein the photocatalyst further comprises magnetic particles (e.g. magnetic nanoparticles) and step a) is carried out under application of an external magnetic field.
53. The process of statement 51, wherein the magnetic particles are nanoparticles having a mean particle size of 2-20 nm.
54. The process of statement 52 or 53, wherein the magnetic particles are paramagnetic or superparamagnetic.
55. The process of statement 52, 53 or 54, wherein the magnetic particles are Fe₃O₄ particles.
56. The process of any one of statements 52 to 55, wherein the photocatalyst comprises 1-50 wt % of the magnetic particles.
57. The process of any one of statements 52 to 56, wherein the strength of the external magnetic field is 0.001-1.0 Tesla.
58. The process of any one of the preceding statements, wherein step a) is conducted in the presence of an infrared (IR) radiation-absorbing material (e.g., Cs_{0.33}WO₃).
59. The process of any one of the preceding statements, wherein the photocatalyst is provided in the form of a powder, particles, pellets, a film or as a fixed bed.
60. A photocatalyst as defined in any one of the preceding statements.

### EXAMPLES

One or more examples of the invention will now be described, for the purpose of illustration only, with reference to the accompanying figures:

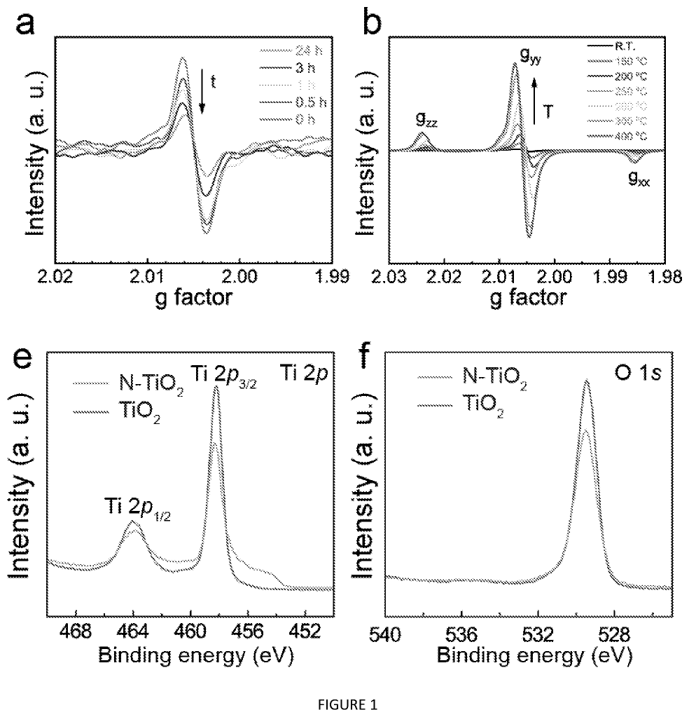

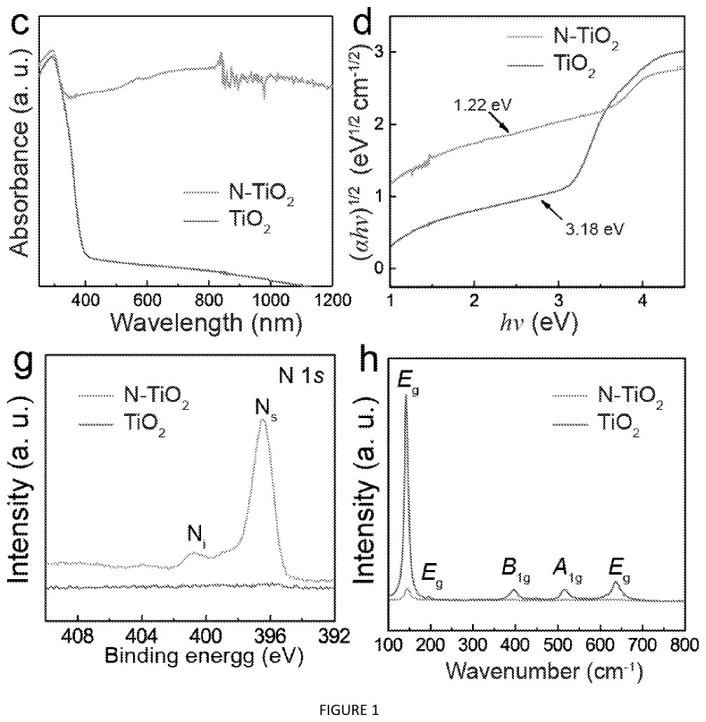

FIG. 1. Characterisations of N—TiO₂. a) EPR spectra of N—TiO₂ exposed to air for different periods after freshly prepared. b) EPR spectra of N—TiO₂ quenched from high-temperature treatment in N₂ environment. c) UV-vis absorption spectra of N—TiO₂ and TiO₂. d) Tauc plots of N—TiO₂ and TiO₂ derived from the UV-vis absorption spectra. XPS spectra of e) Ti 2p, f) O 1s and g) N 1s of N—TiO₂ and TiO₂. h) Raman spectra of N—TiO₂ and TiO₂.

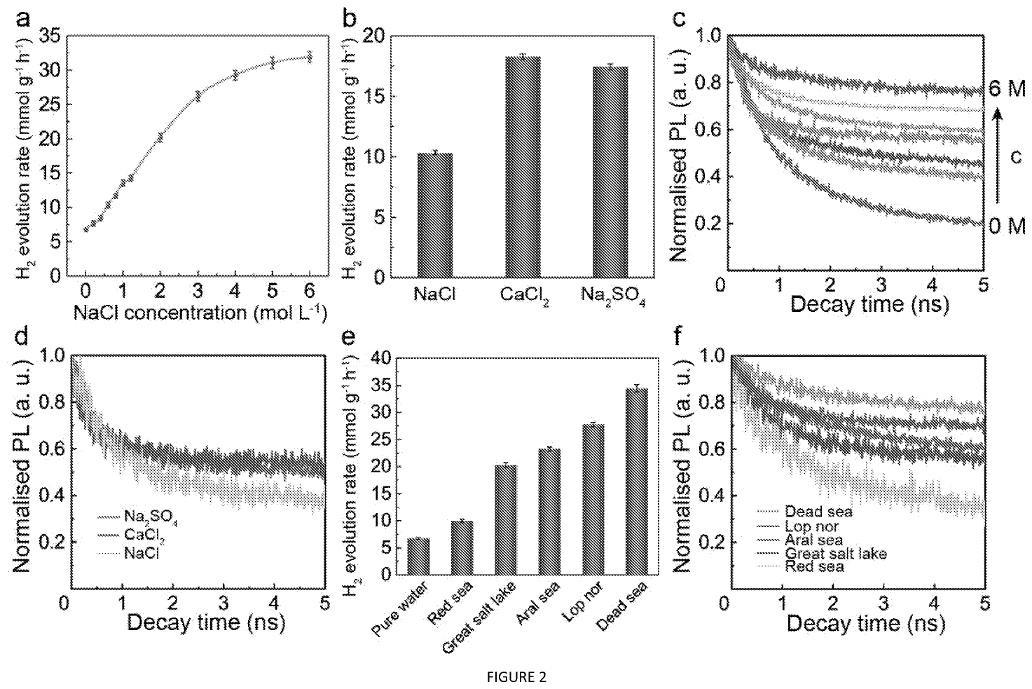

FIG. 2. a) The POWS activity in the NaCl solutions of different concentrations at 270° C. over 1 wt. % Au/N—TiO₂ photocatalyst. b) The POWS activity in 0.6 mol L⁻¹ NaCl, CaCl₂ and Na₂SO₄ solutions at 270° C. over 1 wt. % Au/N—TiO₂ photocatalyst. c) TRPL spectra of 1 wt. % Au/N—TiO₂ in the NaCl solutions of different concentrations (0-6 mol L⁻¹) measured at room temperature. d) TRPL spectra of 1 wt. % Au/N—TiO₂ in 0.6 mol L⁻¹ NaCl, CaCl₂ and Na₂SO₄ solutions measured at room temperature. e) The POWS activity of 1 wt. % Au/N—TiO₂ in different simulated seawaters at 270° C. f) TRPL spectra of 1 wt. % Au/N—TiO₂ soaked in different simulated seawaters measured at room temperature.

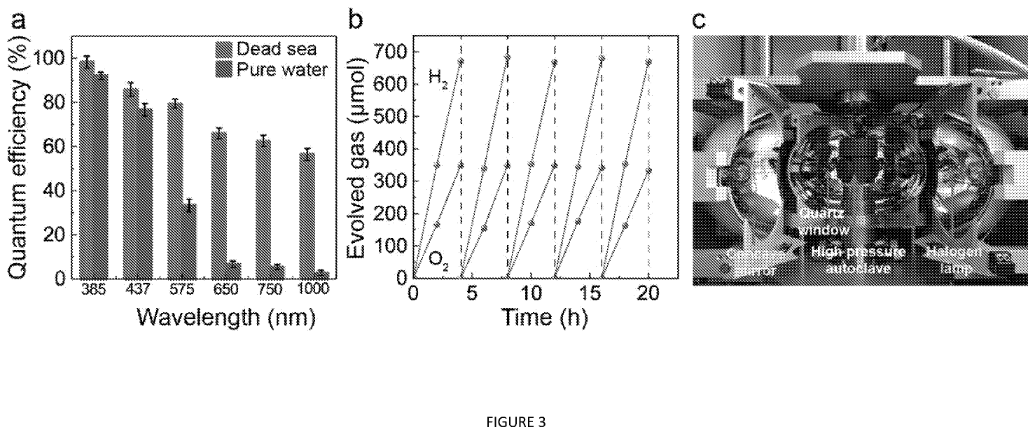

FIG. 3. a) QE of 1 wt. % Au/N—TiO₂ in simulated Dead Sea water at 270° C. Error bars indicate the standard deviation; b) Repeatable tests of 1 wt. % Au/N—TiO₂ in simulated Dead Sea water at 270° C. for 2 h followed by cooling to room temperature in each cycle, respectively. c) A photographic image of a four-mirror floating-zone light furnace from Crystal Systems Inc. used to mimic a solar concentrator to provide both heat and photons to the N—TiO₂ without any other energy input from an electrical device.

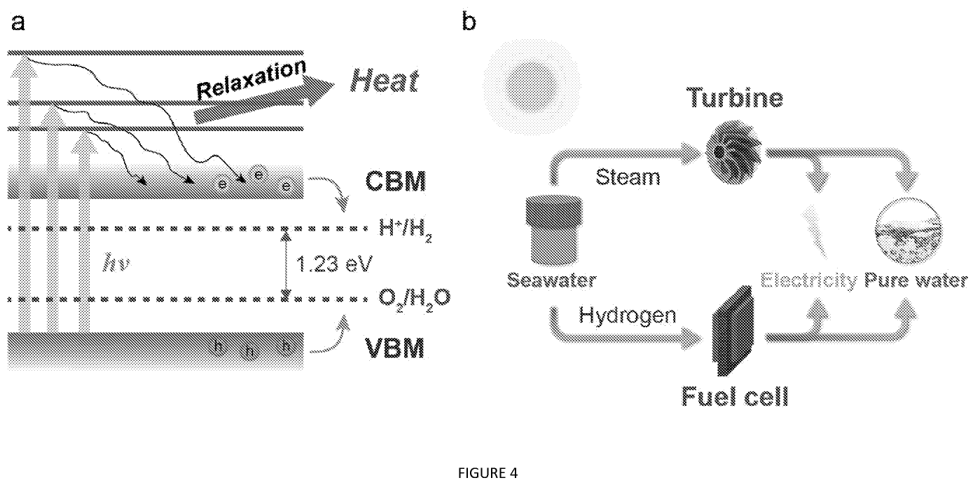

FIG. 4. a) Schematic illustration of the energy conversion processes during the POWS reaction (VBM: valence band maximum; CBM: conduction band minimum). b) A flowchart of the temperature-promoted POWS system using seawater studied in this work.

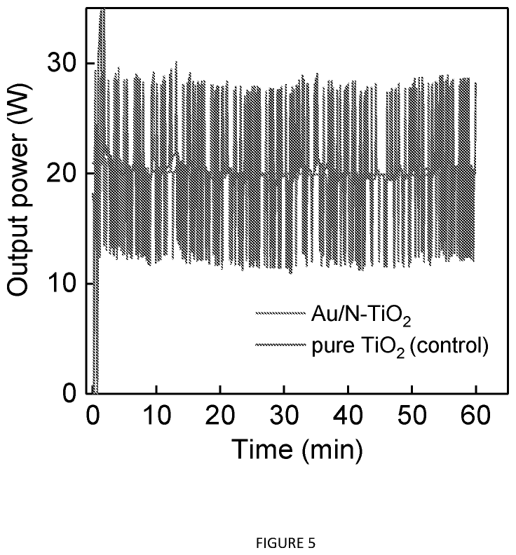

FIG. 5. Typical heating process of the POWS reaction. The output power curves were integrated over the reaction time 1 hour to obtain the total energy used to maintain the reaction temperature of 270° C. In the presence of Au/N—TiO₂ photocatalyst, less electrical energy is required due to the photothermal effect upon illumination. And a control experiment using pure TiO₂ was carried out to exclude the photothermal effect of the light source, reactor, water, etc. The photothermal contribution of the Au/N—TiO₂ photocatalyst can be then evaluated by the difference of the total energy in both cases. Each experiment was repeated for 5 times to evaluate the experimental error.

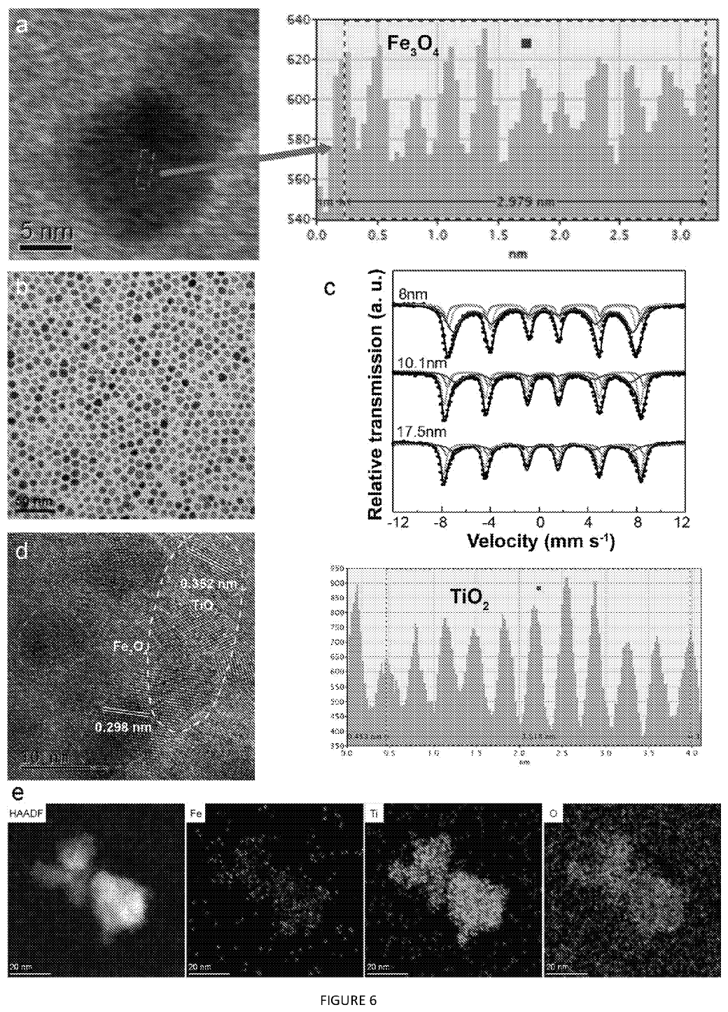

FIG. 6. Microscopic characterisations a) HR-TEM image of an Fe₃O₄ NP, for which the lattice spacing is 0.298 nm, corresponding to the (220) plane of Fe₃O₄ structure;⁹ b) TEM image of 8 nm Fe₃O₄ NPs; c) Mössbauer spectra of the Fe₃O₄ NPs with different mean particle sizes (black: collected overall response curves; blue and red (superparamagnetic): Fe₃O₄ phase; green: Fe₂O₃ phase); d) HR-TEM images of Fe₃O₄/N—TiO₂-2 showing the lattice spacing of 0.352 nm which can be attributed to the anatase TiO₂ (101); e) HAADF-STEM image of Fe₃O₄/N—TiO₂-2 and the corresponding energy dispersive X-ray spectroscopy (EDS) mapping.

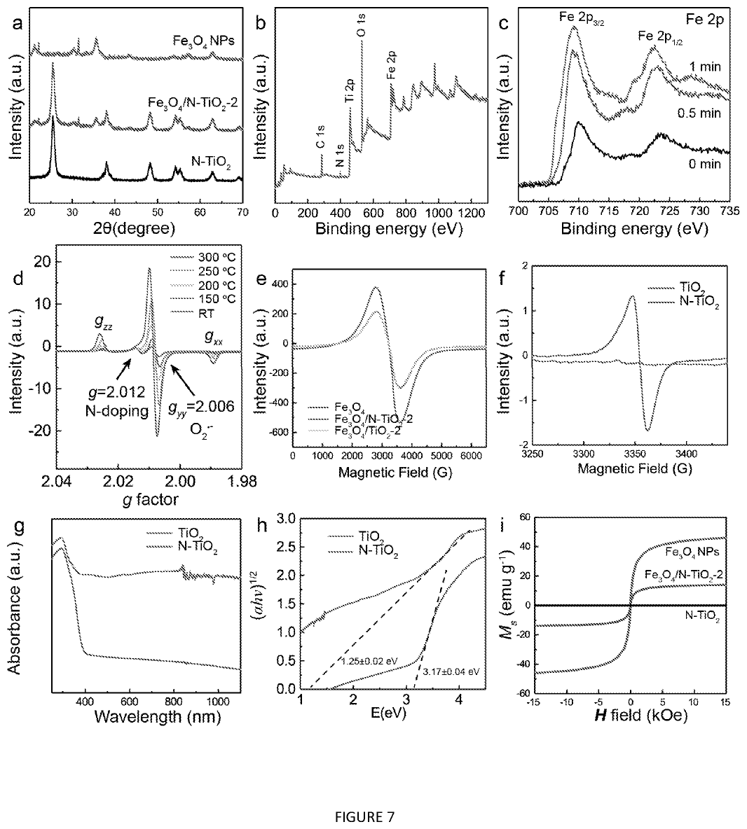

FIG. 7. XRD patterns of Fe₃O₄ NPs, Fe₃O₄/N—TiO₂-2 and N—TiO₂. b) XPS survey spectra of Fe₃O₄/N—TiO₂-2. c) Fe 2p XPS spectra of Fe₃O₄/N—TiO₂-2 obtained at different ion-sputtering time. d) Continuous-wave EPR spectra of N—TiO₂ quenched from the different high-temperature treatment in N₂. e) Selected field-scanning cw-EPR spectra of Fe₃O₄ NPs, Fe₃O₄/N—TiO₂-2 and Fe₃O₄/TiO₂-2. f) Selected field-scanning cw-EPR spectra of N—TiO₂ and TiO₂. g) UV-vis spectra and h) the corresponding Tauc plot of N—TiO₂ and TiO₂. i) magnetisation curves of Fe₃O₄ NPs, Fe₃O₄/N—TiO₂-2 and N—TiO₂.

FIG. 8. a) POWS activity tests of Fe₃O₄/N—TiO₂-2 under the external magnetic field of different strengths. b) magnetisation curves of Fe₃O₄/N—TiO₂-1, Fe₃O₄/N—TiO₂-2, Fe₃O₄/N—TiO₂-3 and Fe₃O₄/N—TiO₂-4 photocatalysts. c) POWS activity tests of N—TiO₂, Fe₃O₄/N—TiO₂-1, Fe₃O₄/N—TiO₂-2, Fe₃O₄/N—TiO₂-3 and Fe₃O₄/N—TiO₂-4 photocatalysts with or without external magnetic field. (NMF=no magnetic field, MF=magnetic field of 180 mT). d) Comparison of the TRPL spectra of Fe₃O₄/N—TiO₂-1, Fe₃O₄/N—TiO₂-2, Fe₃O₄/N—TiO₂-3 and Fe₃O₄/N—TiO₂-4 without magnetic field. e) Comparison of the TRPL spectra of Fe₃O₄/N—TiO₂-2 under magnetic field of different strengths. f) Comparison of the TRPL spectra of Fe₃O₄/N—TiO₂-1, Fe₃O₄/N—TiO₂-2, Fe₃O₄/N—TiO₂-3 and Fe₃O₄/N—TiO₂-4 with an external field of 180 mT.

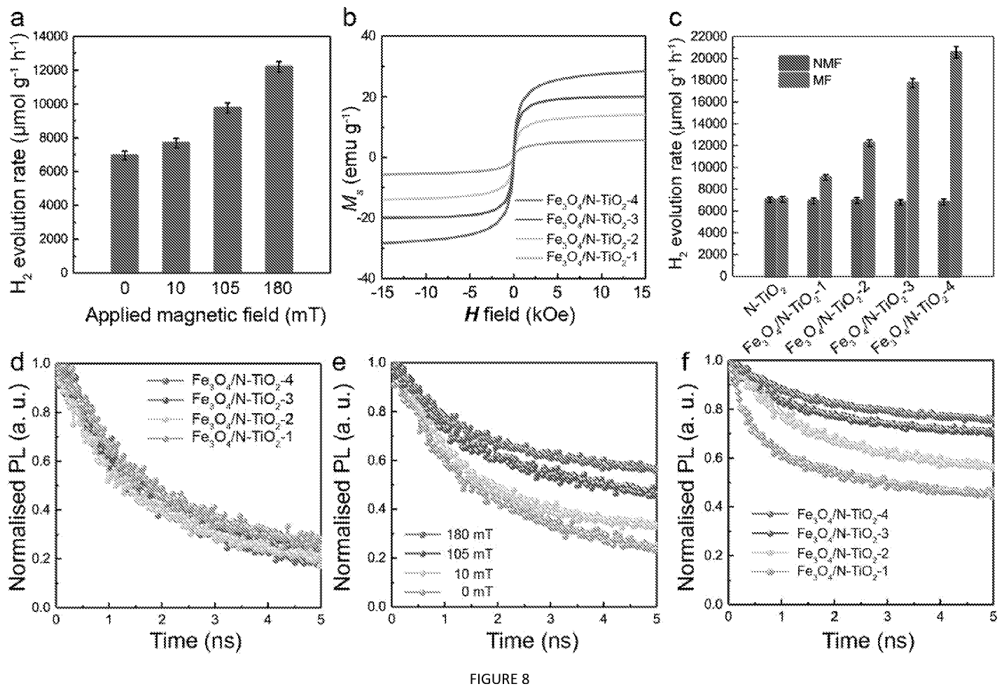

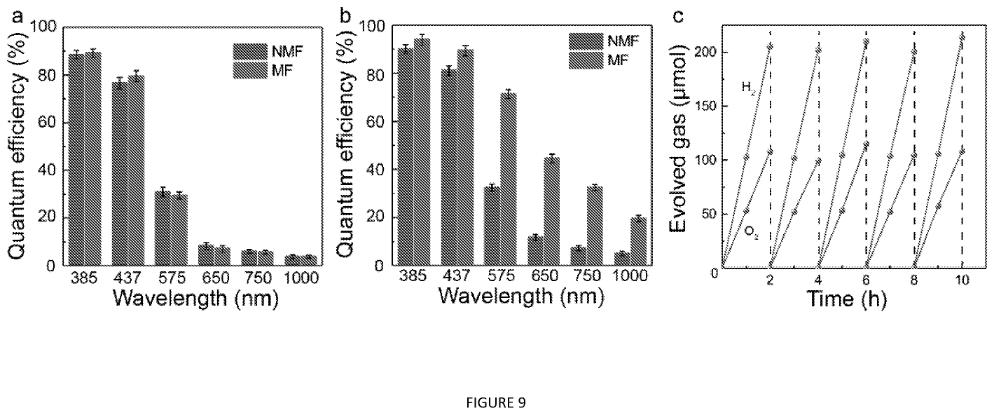

FIG. 9. QE of N—TiO₂ a) and Fe₃O₄/N—TiO₂-4 b) photocatalysts with and without external magnetic field. (NMF=no magnetic field; MF=magnetic field). Each photocatalyst was used after deposition of 1 wt. % Au via photo-reduction method. Error bars indicate the standard deviation; c) Repeatable tests of Fe₃O₄/N—TiO₂-4 photocatalyst at 270° C. and 180 mT for 2 h followed by cooling to room temperature in each cycle, respectively.

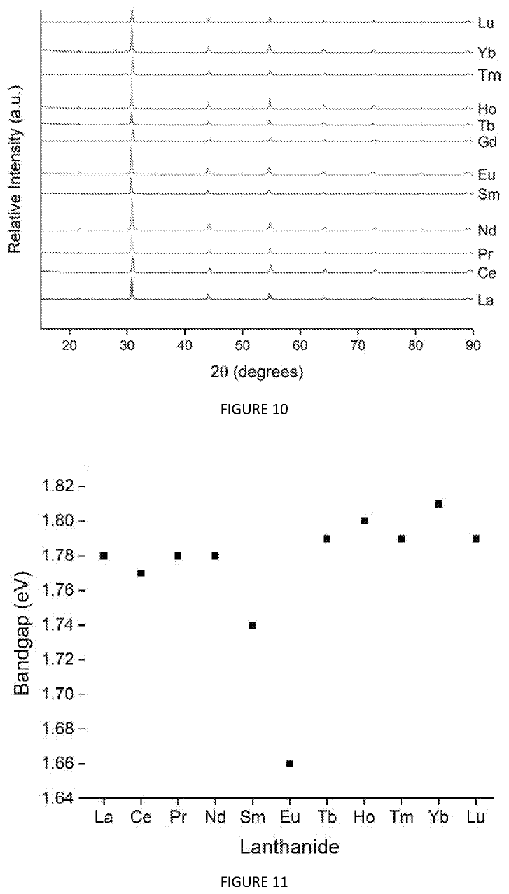

FIG. 10. PXRD patterns of all Ln-BTON samples.

FIG. 11. Bandgap energy of the Ln-BTONs estimated from the Tauc plots of the respective UV-Vis spectra.

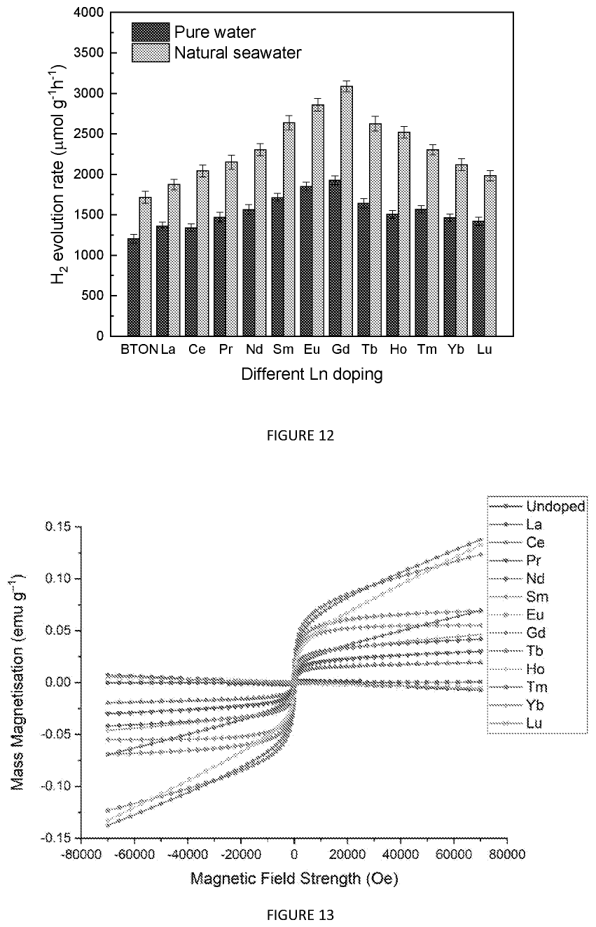

FIG. 12. H₂ evolution rate of BTON and Ln-BTONs. Error bars indicate the standard deviation.

FIG. 13. M-H curves of BTON and Ln-BTON samples from SQUID magnetometer.

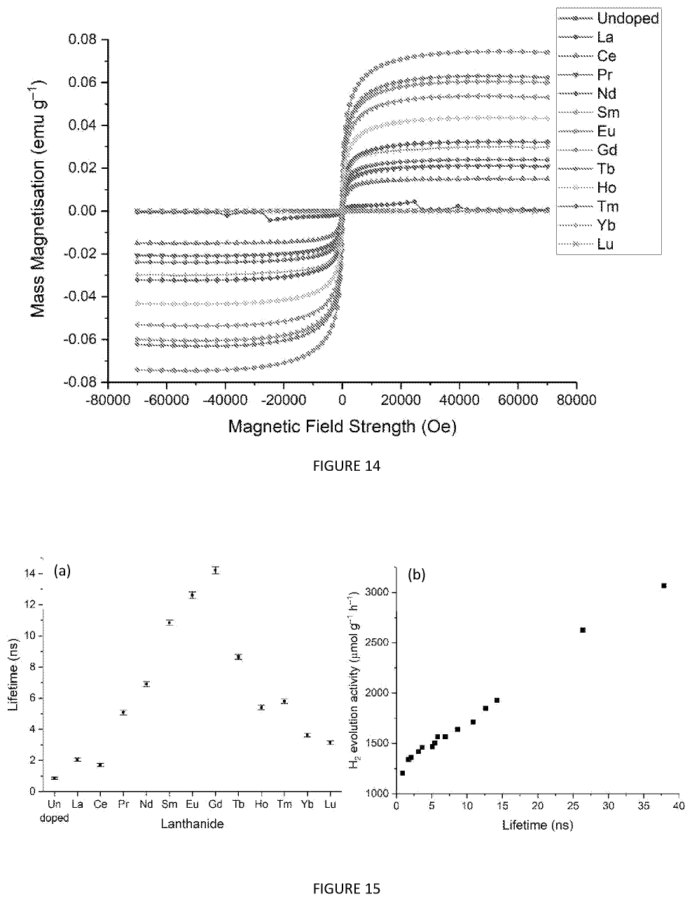

FIG. 14. Ferromagnetic component of the M-H curves obtained by subtracting the linear paramagnetic regions.

FIG. 15. (a) Lifetime of the charge carriers within BTON and Ln-BTON calculated from TRPL spectra, and (b) plot showing the relationship between the lifetime of the charge carriers and the activity of the photocatalyst.

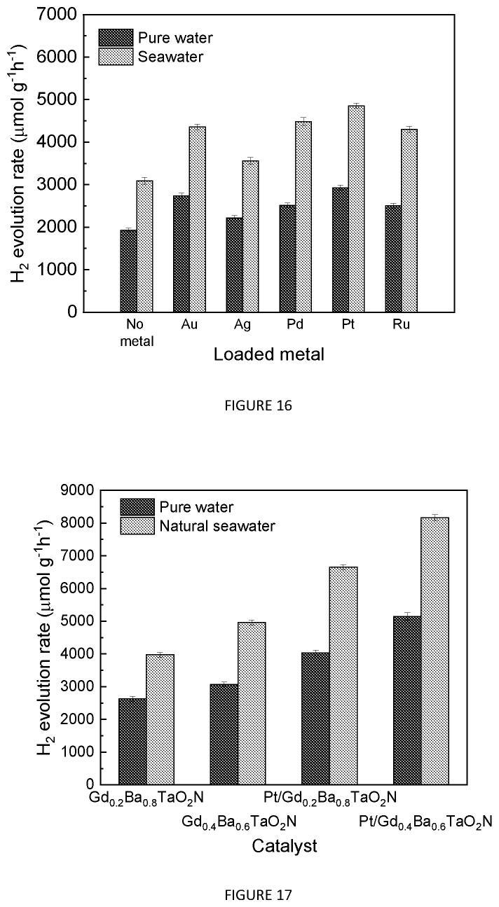

FIG. 16. H₂ evolution rate of Gd-BTON loaded with a variety of noble metal nanoparticles. Error bars indicate standard deviation.

FIG. 17. H₂ evolution rate of Gd_{0.2}Ba_{0.8} TaO₂N and Gd_{0.4}Ba_{0.6} TaO₂N with and without 1 wt. % of Pt nanoparticles, in pure water and natural seawater. Error bars indicate standard deviation.

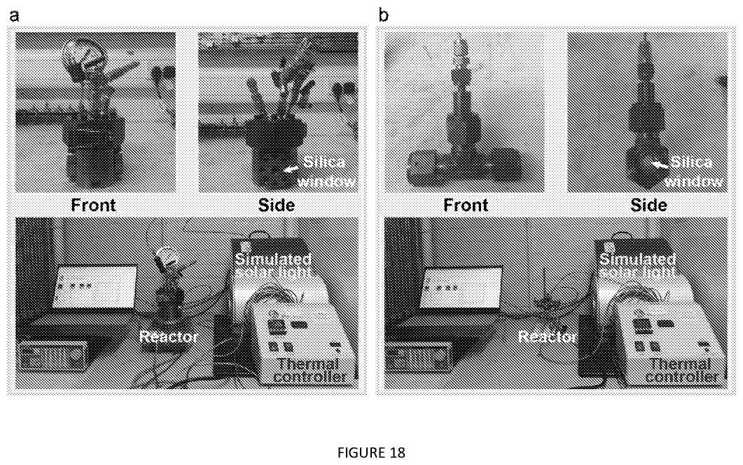

FIG. 18. Two different experimental set-ups for the POWS reaction. The upper row gives two different batch reactors used in this work and the lower row shows the thermal controller, monitoring software and the solar simulator. All solar conversion efficiencies are evaluated on both experimental set-ups to minimise the experimental errors.

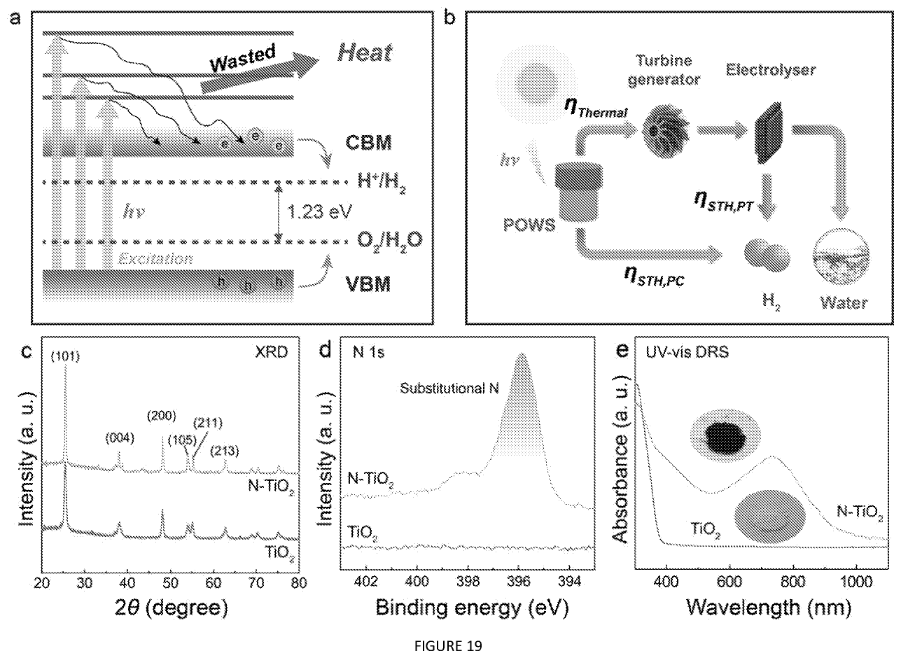

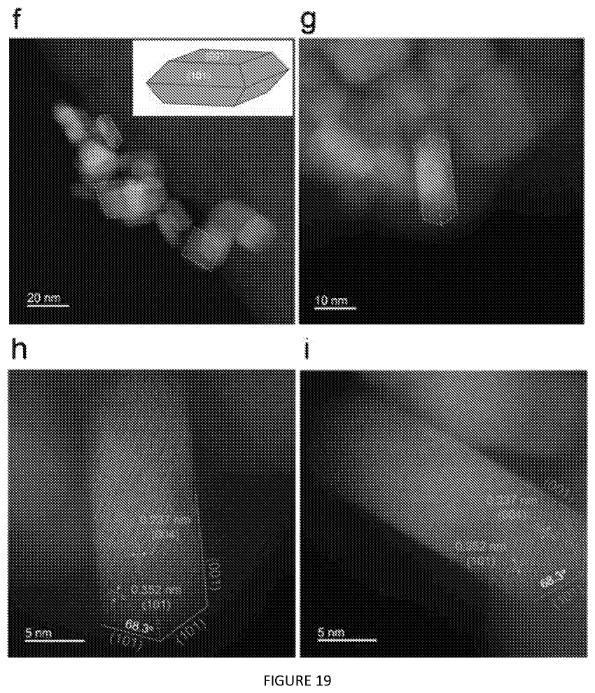

FIG. 19. (a) Schematic illustration of the energy transformation pathways during the POWS reaction (VBM: valence band maximum; CBM: conduction band minimum). As shown, a large portion of solar energy dissipates as heat and is wasted in the conventional POWS systems. (b) Flow chart of the PC-PT water splitting system studied in this work. The efficiencies of different processes are labelled. (c) XRD, (d) N 1s XPS, and (e) UV-vis DRS spectra of the morphology-controlled TiO₂ and N—TiO₂ nanocrystals. Inset of (e): Photographic images of the morphology-controlled TiO₂ and N—TiO₂. (f, g) Low-magnification HAADF-STEM images and (h, i) High-magnification HAADF-STEM images of the morphology-controlled N—TiO₂. Lattice spacings of 0.237 nm and 0.352 nm are labelled in (h) and (i), which are in accordance with the and crystallographic planar directions of anatase TiO₂.

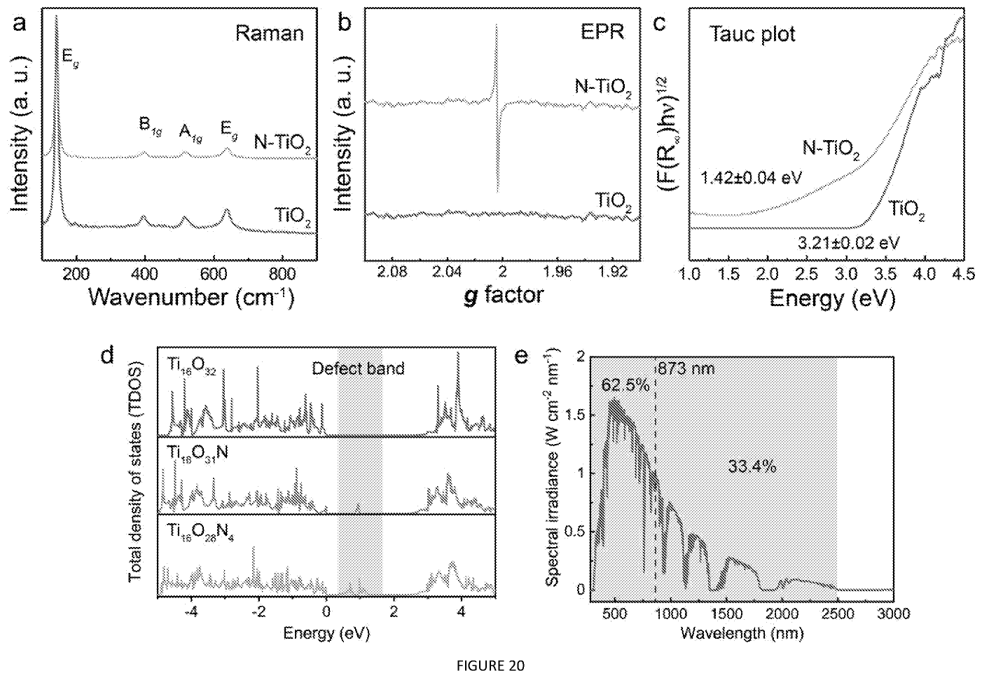

FIG. 20. Structural and spectroscopic characterisations of the facet-engineered TiO₂ and N-doped TiO₂ materials. The Raman spectra (a), EPR spectra (b), and Tauc plots generated from the UV-vis DRS in FIG. 19e in the main text (c) of the morphology-controlled TiO₂ and N—TiO₂ materials. (d) Total density of states (TDOS) of TiO₂ models with different N-doping concentrations obtained from the DFT calculations. The green area indicates the defect band introduced by the N-doping.¹⁰ (e) AM 1.5 G solar spectrum based on the ASTM G173-03 reference. The energy contribution of different wavelength ranges is labelled in the figure. The N—TiO₂ nanocrystals absorbs the visible and near infrared light up to 873 nm, which accounts for 62.5% of solar energy (blue). The IR absorber, Cs_{0.33}WO₃ nanoparticles, is transparent in the visible regime, and absorbs IR ranging from ca. 850 nm to 2500 nm, which accounts for 33.4% of solar energy (green).

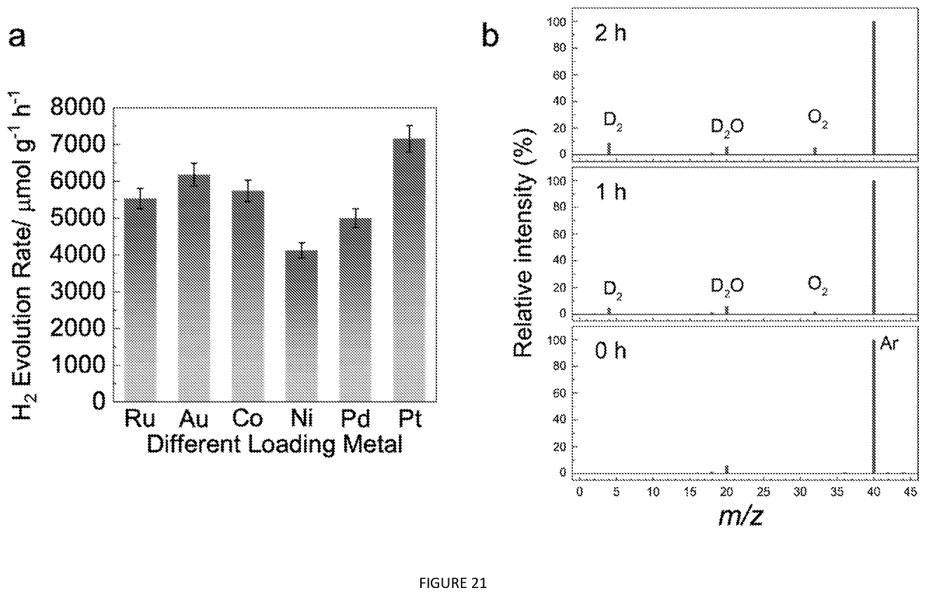

FIG. 21. (a) POWS activities of N—TiO₂ with different metal loadings of 1 wt. % at 270° C. under simulated solar irradiation. Error bars represent the standard deviations. (b) Isotopic study of the POWS reaction on 1 wt. % Pt/N—TiO₂ photocatalyst using heavy water as the reactant. The products were measured by mass spectrometer (Hiden Analytical) after certain reaction time, as indicated in the figure. All signals are re-scaled by the signal of the inert component Ar (The relative intensity of Ar is 100%). As shown, before the reaction, the majority of the gaseous phase is the inert Ar gas (m/z=40), while the signal at m/z=20 and 18 can be assigned to the D₂O vapour. After the reaction of 1 hour, the signals of D₂ (m/z=4) and O₂ (m/z=32) are observed, while the signal of H₂ (m/z=2) is absent. Also, no N₂ signal was detected, which again, indicates that there is no mixed air in the system. When the reaction was performed for another 1 hour, the signals of D₂ and O₂ almost doubled. It should be noted that the mass spectra are only for qualitative analysis since the ionisation properties may greatly vary among different chemical species. While the quantitative information was obtained by GC analysis, as demonstrated in the Method section.

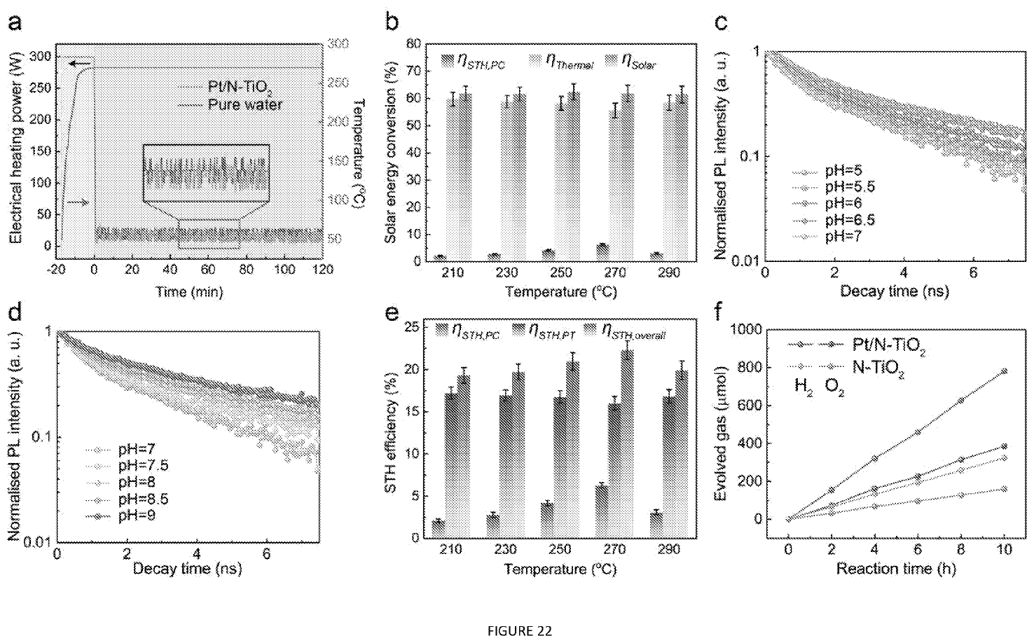

FIG. 22. Performance evaluation of the POWS reaction at elevated temperatures. (a) Heating curves of the POWS reaction operated at 270° C. on the Pt/N—TiO₂ photocatalyst. A control experiment was carried out using pure water at 270° C. The power of the electrical heating device is plotted against the time of experiment, and a zoom-in is given to show the difference of heating powers between the experiments using the Pt/N—TiO₂ suspension and pure water. The total energy input from the electrical heating device can be calculated by integration. (b) PC and PT conversion efficiencies of the POWS reaction over the Pt/N—TiO₂ photocatalyst at 200-300° C., showing the highest η_{STH} at 270° C. which is in accordance with the temperature-dependent ionic dissociation of water. Error bars indicate the standard deviations. (c) TRPL spectra of the N—TiO₂ after being soaked in the HCl solutions with different pH. (d) TRPL spectra of the N—TiO₂ after being soaked in the NaOH solutions with different pH. (e) η_{STH,PC}, η_{STH,PT} and η_{STH,overall} of the POWS reaction on Pt/N—TiO₂ at 200-300° C. Calculation details are shown in Supplementary Notes 1 and 2. Error bars indicate the standard deviations. (f) Stable and stoichiometric decomposition of water to H₂ and O₂ with no sacrificial reagent on the Pt/N—TiO₂ and the N—TiO₂ for 10 hours.

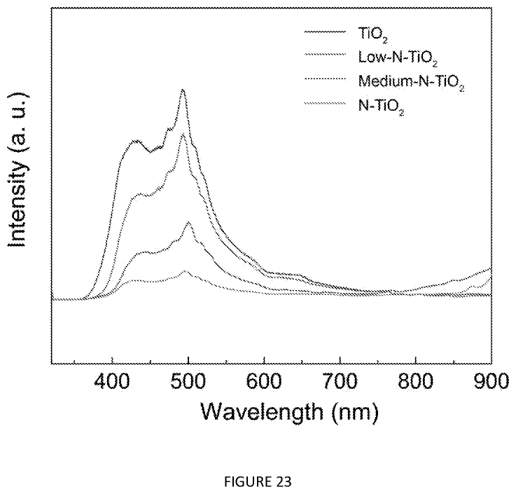

FIG. 23. Fluorescence spectra of TiO₂ and N—TiO₂ with different N-doping concentrations (Excitation wavelength: 300 nm). Each spectrum shows a broad emission band ranging from 400 to 600 nm which is from the intrinsic bandgap emission of anatase TiO₂. Additional emission signals can be observed for N—TiO₂ and N—TiO₂ (Medium) rising from 800 nm, which can be attributed to the recombination between the conduction band and the extra N defect band.

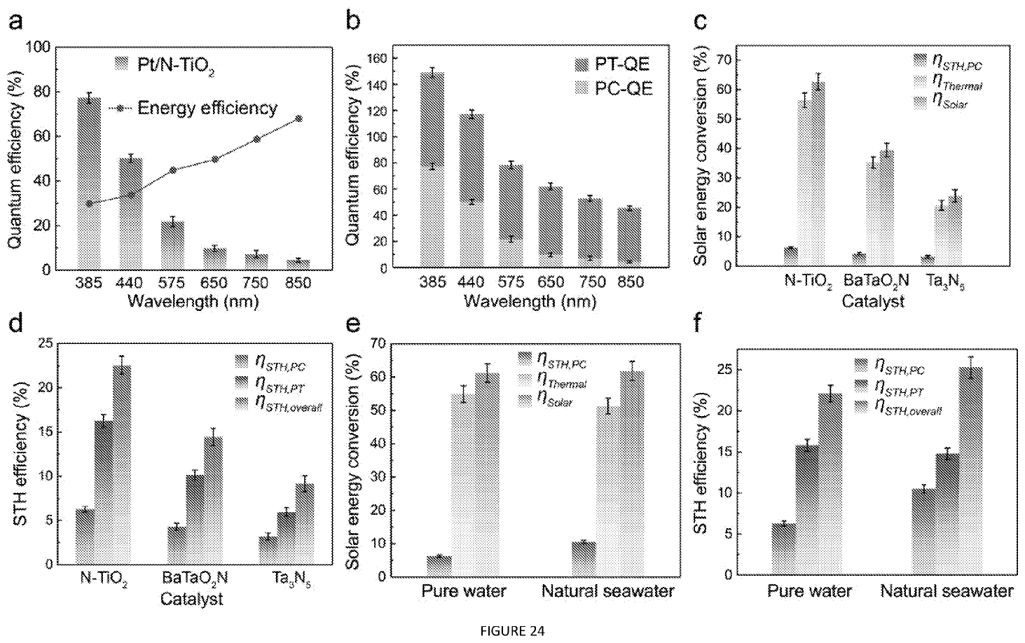

FIG. 24. (A) QE of the Pt/N—TiO₂ at different incident wavelengths of 385, 437, 575, 620, 750 and 850 nm, respectively. The reactor was irradiated by a 300-W Xe lamp equipped with band-pass filters. (b) PT-QE, PC-QE and CQE of the Pt/N—TiO₂ at different wavelengths evaluated at 270° C. Detailed calculations are shown in Supplementary Note 3. (c) PC and PT energy conversion efficiencies of the POWS reaction on N—TiO₂, Ta₃N₅ and BaTaO₂N photocatalysts at 270° C. (d) STH conversion efficiency via PC and PT processes of the POWS reaction on N—TiO₂, Ta₃N₅ and BaTaO₂N photocatalysts at 270° C. All the catalysts were photo-deposited with 1 wt. % of Pt NPs via a photo-deposition method. (e) PC and PT energy conversion efficiencies of the POWS reaction evaluated in pure water and seawater on the Pt/N—TiO₂ at 270° C. (f) STH conversion efficiency via PC and PT processes of the POWS reaction evaluated in pure water and seawater on the Pt/N—TiO₂ at 270° C. All the error-bars indicate the standard deviations. The detailed calculation of the energy efficiencies is shown in Supplementary Notes 1 and 2.

### PART A

### 1. Materials and Methods

### Materials

The reagents used in these examples are the following: Titanium dioxide (Degussa P25, 75% anatase, 25% rutile); Titanium (IV) isopropoxide (reagent grade, Sigma-Aldrich); Iron (III) nitrate nonahydrate (reagent grade, Sigma-Aldrich); Iron (II) chloride (reagent grade, Sigma-Aldrich); Hydrogen tetrachloroaurate trihydrate (reagent grade, Sigma-Aldrich); Isopropanol (99.9%, Sigma-Aldrich); Methanol (anhydrous, ≥99.8% (HPLC), Sigma-Aldrich); Acetic acid (reagent grade, Sigma-Aldrich); H₂SO₄ (≥98%, Sigma-Aldrich); Ammonia gas (anhydrous, BOC); Argon gas (99.99%, BOC); Helium gas (99.99%, BOC); Nitrogen gas (99.99%, BOC).

Synthesis of TiO₂ and N-doped TiO₂

TiO₂ nanoparticles were synthesised via a sol-gel process: solution A was obtained by adding 5 mL of titanium isopropoxide (TTIP) in 15 mL ethanol and solution B is obtained by mixing 10 mL DI water, 10 mL ethanol and 1 mL acetic acid. Then solution A was slowly added to solution B dropwise. A transparent gel forms, which was then aged overnight, following by drying in vacuum oven at 70° C. Then obtained dry gel was then calcined in N₂ atmosphere at 400° C. for 2 h. The as-obtained TiO₂ powders were collected.

The N-doped TiO₂ was prepared by treatment of TiO₂ with pure NH₃. In a typical experiment, 250 mg of TiO₂ powder was put into a quartz boat in a tubular furnace, and then the temperature is elevated to 550-660° C. in a step of 5° C./min in a NH₃ flow. TiO₂ was treated with NH₃ for 8 h before cooling down to room temperature naturally.

Synthesis of the Fe₃O₄ magnetic nanoparticles and Fe₃O₄@SiO₂ Magnetic Nanoparticles

The synthesis method was modified from a previous study.⁹ The iron-oleate complex was first prepared by reacting metal chlorides and sodium oleate. Typically, 1.08 g of FeCl₃·6H₂O and 3.65 g of sodium oleate were firstly dissolved in a mixture of 8 mL of ethanol, 6 mL of distilled water, and 14 mL of hexane. The resulting solution was then heated to 70° C. and maintained for 2 h, after which the upper organic layer containing the iron-oleate complex was washed three times with distilled water. Hexane was evaporated off after washing and iron-oleate complex was obtained in solid form. For the preparation of 8 nm Fe₃O₄ NPs, 20 mg of the iron-oleate complex and 300 μL of oleic acid were dissolved in 20 mL of 1-octadecene at room temperature. Then the mixture was heated to 310° C. with a constant heating rate of 5° C. min⁻¹, and kept for 30 min before cooled to room temperature. Ethanol was then added to the mixture, resulting in a black precipitate, which was separated via centrifugation. The product was then washed with isopropanol/hexane several times and dried in an oven. The Fe₃O₄ nanoparticles with different mean particle sizes were also prepared by the same procedure by controlling the amount of oleic acid (450 μL for 10.1 nm; 600 μL for 17.5 nm).

Fe₃O₄@SiO₂ was prepared from reverse micelles using a previously reported procedure.⁹ Briefly, Fe₃O₄ nanoparticles (2 mg) and 100 μL of TEOS were added to a heterogeneous solution containing cyclohexane (24 mL), hexanol (4.8 mL), Triton X-100 (6 mL), and deionised water (1 mL). After 6 h of stirring, NH₃·H₂O (30 wt. %) (100 mL) was added to initiate the hydrolysis of TEOS. The reaction was allowed to continue for another 24 h with stirring at room temperature. The product was well dispersed in ethanol and further purified by centrifugation (14000 rpm, 10 min).

Synthesis of the Fe₃O₄/N—TiO₂ and Fe₃O₄@SiO₂/N—TiO₂ Photocatalysts

Fe₃O₄/N—TiO₂ and Fe₃O₄@SiO₂/N—TiO₂ photocatalysts were synthesised following a similar procedure, but adding Fe₃O₄ or Fe₃O₄@SiO₂ nanoparticles to solution A at the beginning. Photocatalysts containing different amount of Fe₃O₄ were also synthesised by this method by changing the amount of Fe₃O₄NPs added to solution A. The Fe₃O₄NPs content was calculated to be 10%, 20%, 30% and 40 wt %, and the as-obtained samples were denoted as Fe₃O₄/N—TiO₂-1, Fe₃O₄/N—TiO₂-2, Fe₃O₄/N—TiO₂-3 and Fe₃O₄/N—TiO₂-4, respectively.

Photocatalysts were all used after treatment with supporting Au nanoparticles (1.0 wt. %) via a photo-deposition method: 50 mg of as-obtained photocatalysts was suspended in 60 mL methanol aqueous solution (50 vol. %) under vigorous stirring, and a certain amount of solution containing Au precursor was then added into the above suspension. This suspension was irradiated under a 300W ultraviolet lamp (Helios Italquartz S.R.L.) for 2 hours before being filtered and washed with water and ethanol for 3 times, respectively. The final products were obtained after drying in a 70° C. oven overnight.

### Photocatalytic Water Splitting Activity Tests

The POWS activity was determined by measuring the amount of hydrogen and oxygen evolved from the water splitting. The reactions were carried out in a close 25-mL stainless-steel autoclave equipped with two quartz windows (10 mm in diameter and 18 mm in thickness) and a glass lining (20 mm i.d.×24 mm o.d.×52 mm height). 1 wt. % of Au was deposited on all the photocatalysts via the photo-reduction method before testing. In a typical experiment, a certain amount of photocatalyst which contained 5 mg of TiO₂ was added to 10 mL of Milli-Q H₂O under vigorous magnetic stirring (600 rpm); then the autoclave was pressurised with 6-bar of Ar gas after being well sealed. The particulate suspension in the reactor was then heated up to 270° C. at its saturated equilibrium pressure of water. Tungsten light (70W, Glamox Professional 2000) was then applied through the quartz windows to provide visible-light irradiation after the autoclave reached 270° C. External magnetic field was provided by two paralleled identical magnets. The field strength was modified by changing the distance between the magnets and measured by a Gauss/Tesla meter (Dexing Magnet, DX-150). After a 2-h reaction, the autoclave was allowed to cool down naturally to room temperature, and the amounts of hydrogen and oxygen were measured by a gas chromatograph (GC) equipped with thermal conductivity detectors (TCD) with He and N₂ as carrier gases, respectively.

### Photocatalytic Overall Water Splitting Activity Tests in Simulated Seawater

The POWS reaction was carried out in a 25-mL stainless steel batch reactor equipped with two quartz windows (10 mm in diameter and 18 mm in thickness each). In a typical experiment, 5 mg catalyst is added to 10-mL aqueous solution (simulated seawater) in a glass lining (20 mm i.d.×24 mm o.d.×52 mm height) under magnetic stirring (750 rpm), then the autoclave was pressurized with 6 bar of inert Ar gas after well-sealed. The reactor would then be allowed to heat up to certain elevated temperature with its saturated water vapour pressure. Tungsten light (UV-cut, 70 W, Iwasaki Electric Co., LTD.) was then applied through the quartz windows to provide visible light irradiation, of which the power was measured to be 48 mW/cm² in the centre of the reactor. The autoclave was cooled down naturally to room temperature after reaction and the amounts of hydrogen and oxygen were measured by gas chromatography (GC) equipped with two thermoconductivity detectors (TCD) with He and N₂ as carrier gas, respectively.

### Quantum Efficiency (QE) and Solar-to-Hydrogen (STH) Efficiency Measurements and Calculation

The apparent QE was measured in the same autoclave and the POWS performance was evaluated by adding a certain amount of photocatalyst which contained 50 mg of TiO₂ to 10 mL of Milli-Q H₂O under vigorous magnetic stirring (600 rpm), then the autoclave was irradiated by a 300-W Xenon lamp (Newport) equipped with band-pass filters of 385±20, 437±10, 575±25, 650±20, 750±20 and 1000±20 nm, respectively. The relevant number of photons was calculated from the irradiation powers in each wavelength region measured by a light meter at the corresponding wavelengths. The apparent QE can be calculated by using the equation:

$$QE ( \% ) = \frac{Number of evolved hydrogen molecules \times 2}{Number of incident photons} \times 100 \% \qquad Eq . 1$$

The STH efficiency was also measured by a similar procedure, but the suspension was then irradiated by a VeraSol solar simulator (100 mW cm⁻²). The amounts of hydrogen and oxygen were measured by a gas chromatograph (GC) equipped with thermal conductivity detectors (TCD) with He and N₂ as carrier gases, respectively. The STH can be calculated by the following equation:

$$STH ( \% ) = \frac{Evolved hydrogen amount \times 237 \text{kJ/} mol}{P \times S \times t} \times 100 \% \qquad Eq . 2$$

Where the power of solar irradiation is 100 mW cm⁻², and S is the irradiation area, t is the reaction time.

### X-Ray Diffraction (XRD)

XRD measurements were performed on a Bruker D8 Advance diffractometer with LynxEye detector and Cu Kα1 radiation (λ=1.5406 Å), operating at 40 kV and 25 mA (step size at 0.019°, time per step at 0.10 s, total number of steps at 4368). Samples were pressed onto a glass preparative slide and scanned at 2θ angles of 5-90°.

### X-Ray Photoelectron Spectroscopy (XPS)

XPS measurements were carried out on the Thermo Scientific model Nexsa. The aluminium anode tube for the X-ray emission was operated at a voltage of 12 kV and kept constant during all measurements. Survey scans were obtained at a pass energy of 200 eV, 5 scans with step size 1 eV, whereas for those detailed spectra 50 eV pass energy, 10 scans with 0.1 eV step size were used. The XPS depth profiling was performed by etching the sample with Ar sputtering. The sample was etched with 3 keV Ar⁺ ions at an angle of incidence (θ) of 45° to the normal surface of the sample. Etching time was varied to obtain the information of different depths.

### Electron Paramagnetic Resonance (EPR)

Continuous-wave EPR spectra were obtained by using an X-band (9.4 GHZ) Bruker EMX EPR spectrometer. All measurements were carried out at 293 K. 10 mg powder of each sample was weighed and put into a glass EPR tube (0.60 i.d. and 0.84 o.d.). Then all X-Band spectra were collected over a 7000 Gauss field range and 5 scans were adopted for each measurement. Signal intensity vs. electron spin numbers were calculated from the double integral of a defined peak range of the spectra.

### Ultraviolet-Visible Diffuse Reflectance Spectroscopy (UV-Vis DRS)

UV-vis DRS spectra were obtained from a Perkin Elmer Lambda 750S UV-visible spectrometer at room temperature. 50±5 mg of each sample was loaded and pressed onto a sample holder and UV-vis spectra were recorded within the wavelength range of 200-800 nm.

### Time-Resolved Photoluminescence (TRPL) Spectroscopy

Photoluminescence spectra and corresponding lifetimes of excitons were obtained from a bespoke micro-photoluminescence setup, in which a Ti-Sapphire laser (λ=266 nm, pulse duration=150 fs, repetition rate=76 MHZ) was directed onto the sample. Time-resolved measurements were performed using the spectrometer as a monochromator before passing the selected signal to a photomultiplier tube (PMT) detector with an instrument response function width of ˜150 ps connected to a time-correlated single-photon counting module.

The exciton lifetime is obtained by fitting corresponding background-corrected PL spectra with a mono-exponential decay function of the form y=A₁ exp (−x/t₁)+y₀. Errors in the fitting were determined using a least square method.

### Magnetisation Curve Measurements (M-H Curve)

MPMS static magnetic properties of the samples were measured using a superconducting quantum interference device (SQUID, Quantum Design-XL-5).

### Scanning Transmission Electron Microscopy (STEM)

STEM and energy-dispersive X-ray (EDX) spectroscopy were carried out at 200 kV on an FEI Titan TEM equipped with an aberration corrector, a high-angle annular dark-field (HAADF) detector and a Super-X EDX system. Off-axis electron holography was carried out using a single electron biprism. The exposure time for each recorded electron hologram was 30 s. Phase images were reconstructed from holograms using Fourier processing in Gatan Digital Micrograph software.

### 2. Effect of the Local Electric Field Introduced by Ionic Species

Nitrogen-doped TiO₂ (N—TiO₂) was prepared using the NH₃ treatment method reported in a previous study, which has been comprehensively characterised by EPR spectroscopy, UV-vis spectroscopy, XPS, and Raman spectroscopy, etc.¹¹ (FIG. 1). To understand the effect of ionic species, NaCl solutions of different concentrations were used firstly instead of seawater to avoid complexity. Bearing in mind that the salt concentration of seawater varies in different locations with a global average of around 0.6 mol L⁻¹, a wide range of NaCl concentrations up to 6 mol L⁻¹ were first investigated, as shown in FIG. 2a. Clearly, the POWS performances increase proportionally with the concentration of NaCl in the range of 0-3 mol L⁻¹, showing an enhancement from 6746 to 26160 μmol g⁻¹ h⁻¹, while the enhancement becomes less significant when the concentration is higher than 3 mol L⁻¹. A common concern of photocatalysis in seawater (or solutions containing Cl-ions) is that the Cl-oxidation may take place during the photocatalytic splitting of seawater, resulting in the production of corrosive species. According to Eq. 1 and Eq. 2, the Cl⁻ oxidation will inevitably lead to a pH increase of the solution. Thus, pH was measured before and after the reaction, which showed no obvious change, indicating there was no Cl⁻ oxidation observed in this system probably due to the high oxidation potential of Cl⁻ (E_{(Cl2/Cl-)}=1.36 V vs. NHE compared with E_{(O2/H2O)}=1.23 V vs. NHE at pH=0). Gas chromatograph (GC) analysis of the gaseous product also showed no sign of Cl₂.

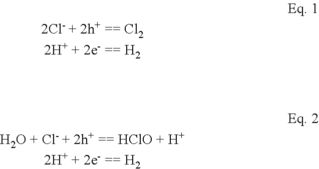

Further studies were then carried out likewise on other salts, including Na₂SO₄ and CaCl₂. POWS reaction was performed using 0.6 mol L⁻¹ of Na₂SO₄ and CaCl₂ aqueous solutions, respectively. Clearly, Na₂SO₄ and CaCl₂ showed positive effect on this reaction, which is even more significant than that in 0.6 mol L⁻¹ of NaCl solution, leading to hydrogen evolution rates of ca. 18000 μmol g⁻¹ h⁻¹ (FIG. 2b). It should be noted that the ionic strength is dependent on not only the concentration but also the composition of the electrolyte, as shown in the Eq. 3. Thus, ionic strengths were calculated for each solution, and the ionic strengths of Na₂SO₄ and CaCl₂ solutions are 3 times of that of the NaCl solution with the same concentration according to Eq. 3. The POWS activities measured in 0.6 mol L⁻¹ Na₂SO₄ and CaCl₂ solutions are similar to that in 1.8 mol L⁻¹ NaCl solution (FIGS. 2a and 2b), which means all the three electrolytes exhibit similar enhancement effect on the POWS performance. Organic compound, sodium dodecyl sulphate, which is the main component of many hygiene products, was studied likewise. Even though the hydrogen evolution rate was enhanced by 55%, no oxygen was detected in the gas phase after reaction. Instead, CO₂ and CO were observed by GC analysis, which indicated that the organic compound can act as a sacrificial reagent in this system, leading to some unwanted carbon emission.

$$I = \frac{1}{2} {\sum }_{i}^{n} {c}_{i} {Z}_{i}^{2} \\ ( I — ionic strength ; {c}_{i} — concentration ; {Z}_{i} — charge ) \qquad Eq . 3$$

To deeply investigate the influence of ionic species on the behaviour of photo-generated charge carriers, TRPL spectroscopy was then engaged. The TRPL spectra of Au/N—TiO₂ photocatalyst were obtained with the sample being soaked in different aqueous solutions (FIGS. 2c and 2d). The obtained spectra were fitted using biexponential function (summarised in Table 1). Clearly, there are two decay components, of which the fast component can be attributed to the intrinsic recombination process of TiO₂ in the bulk region, which is hardly influenced by the ionic species in the solution. However, a slow component was also differentiated which showed positive correlation with the ionic strength of the solution, therefore, it is attributed to the suppressed recombination due to the LEF of the ionic species near the surface. The average exciton lifetimes were greatly prolonged in the aqueous solutions. Moreover, the POWS performances increase with the exciton lifetimes. Also noteworthy is that the acidic or alkaline compounds, such as HCl or Na₂CO₃, which considerably change the pH of the solution, although substantially prolong the exciton lifetimes,¹¹ showed no enhancement to the POWS performance, but even decelerated the reaction. This is because such acidic or alkaline compounds substantially suppress the water dissociation, resulting in much lowered concentration of OH⁻ or H⁺, which is kinetically unfavourable for the corresponding O₂ or H₂ evolution reactions.

TABLE 1
Exciton lifetimes of the 1 wt. % Au/N-TiO₂ in
different environment.ª

| | Ionic | | | | | |
|---|---|---|---|---|---|---|
| | strength | f₁ | | f₂ | | |
| Solution | (mol L⁻¹) | (%) | τ₁ | (%) | τ₂ | τ_{average} |
| Pure water | 0 | 22.1 | 0.75 | 77.9 | 2.96 | 2.48 ± 0.02 |
| 1M NaCl | 1 | 8.2 | 0.69 | 91.8 | 4.30 | 4.01 ± 0.03 |
| 2M NaCl | 2 | 10.9 | 0.76 | 89.1 | 4.97 | 4.51 ± 0.03 |
| 3M NaCl | 3 | 7.2 | 0.65 | 92.8 | 5.56 | 5.21 ± 0.04 |
| 4M NaCl | 4 | 7.3 | 0.69 | 92.7 | 6.52 | 6.10 ± 0.05 |
| 5M NaCl | 5 | 6.1 | 0.73 | 93.9 | 6.94 | 6.56 ± 0.06 |
| 6M NaCl | 6 | 5.4 | 0.76 | 94.6 | 7.64 | 7.27 ± 0.06 |
| 0.6M Na₂SO₄ | 1.8 | 8.8 | 0.70 | 91.2 | 4.67 | 4.32 ± 0.03 |
| 0.6M CaCl₂ | 1.8 | 9.9 | 0.76 | 90.1 | 4.73 | 4.34 ± 0.03 |
| 0.6M NaCl | 0.6 | 11.2 | 0.67 | 88.8 | 3.94 | 3.57 ± 0.02 |
| Dead sea | 6.5 | 3.6 | 0.65 | 96.4 | 7.86 | 7.61 ± 0.06 |
| Lop Nor | 5.42 | 6.8 | 0.68 | 93.2 | 7.10 | 6.66 ± 0.05 |
| Aral Sea | 4.66 | 7.4 | 0.66 | 92.6 | 6.52 | 6.09 ± 0.03 |
| Great Salt | 4.17 | 7.8 | 0.66 | 92.2 | 6.20 | 5.76 ± 0.03 |
| Lake | | | | | | |
| Red sea | 0.71 | 11.3 | 0.67 | 88.7 | 4.05 | 3.67 ± 0.02 |

^{a}τ₁ and τ₂ are the lifetime of the slow and the fast decay components; τ_{average} is the average exciton lifetime; f₁ and f₂ are the contribution of the slow and the fast decay components to the average exciton lifetime; ionic strengths are calculated from the Eq. 3.

With it being clear that the POWS activity of Au/N—TiO₂ can be greatly enhanced by using different aqueous solutions due to the LEF of the ionic species, it was decided to explore more complicated cases, namely seawater. As is well known, seawater contains various ionic species, mainly including Na⁺, K⁺, Ca²⁺, Cl⁻, etc. Although the global average salt concentration of seawater is 3.5 wt. % (ca. 0.6 mol L⁻¹), extreme cases like the Dead Sea has a high ionic strength of more than 6 mol L⁻¹. Given the difficulties involved in collecting natural seawater samples from across the globe, seawater of several different areas of the world were simulated in a lab setting using analysis data from literature¹²⁻¹⁵. Impressively, enhancement of the POWS performances was observed in the simulated seawaters to different extents, as shown in FIG. 2e. The pH of the solutions was measured before and after the reactions, which showed no detectable change, indicating the stoichiometric splitting of water and no other side reactions taking place. Not surprisingly, the Dead Sea water which contains the most concentrated ionic species shows the highest POWS activity of 34435 μmol g⁻¹ h⁻¹, followed by the Lop Nor which exhibits a H₂ evolution rate of 27728 μmol g⁻¹ h⁻¹. The Red Sea, which has a total ionic strength of ca. 0.6 mol L⁻¹, gives a H₂ evolution rate of 9972 μmol g⁻¹ h⁻¹. TRPL studies were carried out likewise, which not surprisingly indicated that the exciton lifetimes were prolonged to different extents in the simulated seawaters (FIG. 2f). The longest average exciton lifetime of 7.27 ns was observed when soaking the N—TiO₂ in the Dead Sea water, while the fastest recombination was in the Red Sea. Moreover, similar to before, both the fast and slow decay components were observed in each TRPL spectrum. The exciton lifetimes showed the same trend as that of the POWS performances in the simulated seawaters, suggesting that the ionic species in the simulated seawaters largely prolong the exciton lifetimes of Au/N—TiO₂ photocatalyst and lead to much enhanced POWS performances.

To further evaluate the performances of this novel particulate POWS system, QEs and STH efficiency measurements were subsequently carried out, both of which are generally recognised as key parameters when considering the practical application potential of a photocatalytic system. As is well-known, QE concerns about the number of photons at a certain wavelength that are converted to H₂ molecules, while STH focuses on the overall energy conversion efficiency over the whole solar spectrum. In this study, QEs of Au/N—TiO₂ were evaluated at different wavelengths using a 300-W Xe lamp equipped with bandpass filters of different wavelengths, and STH was tested with standard AM 1.5G simulated solar light generated by a VeraSol solar simulator with the average intensity of 100 mW cm⁻². FIG. 3a compares the QEs of Au/N—TiO₂ in pure water and in the simulated Dead Sea water, which clearly indicates the remarkable enhancements by the ionic species. Although both showed good QEs at 385 nm and 437 nm, the QEs in pure water dropped dramatically at 575 nm, while those in the Dead Sea water maintained at a high QE level of more than 60% and showed a QE of 56.4% even at the near infrared regime (1000 nm). Additionally, using Au/N—TiO₂ photocatalyst, an extraordinary STH of 20.3±0.4% was also achieved from this POWS system in the simulated Dead Sea water, which to the best of knowledge, surpasses all the reported results in similar particulate systems. Stability of the Au/N—TiO₂ photocatalyst was evaluated by recycling the catalysts for 5 times, which showed stable and stoichiometric evolution of H₂ and O₂ without obvious change of the photocatalytic activities (FIG. 3b). To further demonstrate the technical feasibility of using solely the solar energy to supply the thermal heat and visible light photons required by this novel photocatalytic water splitting process, a high-intensity floating-zone light furnace was used to mimic the solar-light concentrator without any other energy input from an electrical device (FIG. 3c). The reactor temperature of 270° C. can be maintained by this intense concentrated light source with the black-body radiation, and a H₂ evolution rate of about more than 40 mmol g⁻¹ h⁻¹ is achieved by using Au/N—TiO₂ for up to 20 hours.

Moreover, it is noteworthy that conventional photocatalytic water splitting systems under ambient conditions only consider the STH conversion, however, a large portion of the solar energy is actually converted to heat due to the charge relaxation process or surface plasmonic effect. As shown in FIG. 4a, electrons near the VBM are firstly excited to the CB by absorbing photons, then they relax to the CBM, and release the energy in the form of heat during relaxation. The electrons and holes subsequently react with the adsorbed H⁺ and OH⁻ ions, respectively, and the excess energy is also released to the surrounding environment as heat. Taking a photon of 400 nm (equivalent of a photon energy of 3.1 eV) as an example, only around 40% of the photon energy can be finally converted to chemical energy in H₂ (1.23 eV), while the rest is released as heat or photoluminescence. However, the use of the generated heat is scarcely considered because it is extremely hard at the ambient condition. In this work, it was demonstrated that 23.8±1.3% of the solar energy could be converted to thermal energy and then released to the environment (i.e. superheated water and steam in this POWS system). In this POWS system at elevated temperature, seawater is photocatalytically split to H₂ and O₂ in the presence of photocatalyst at an elevated temperature. The generated H₂ can then be used as a chemical fuel in a fuel cell; meanwhile, the superheated steam can be subsequently injected into a steam turbine to generate electric energy in order to achieve a more efficient conversion of the solar energy and the steam is converted to purified water (FIG. 4b). Overall, the whole process converts the solar energy and seawater to electric energy and pure water, respectively.

The photothermal energy conversion was evaluated by monitoring the heating process of the POWS system at 270° C. Typically, the photocatalytic reactor is heated up to 270° C., precisely controlled by a Parr thermo-controller under the PID control mode. The photocatalytic system is wrapped by quartz wool and aluminium foil to minimise the heat loss. Upon illumination, the Au/N—TiO₂ photocatalyst absorbs the photons and converts part of the energy to heat, which is then released to the surrounding environment. Obviously, the thermo-controller will provide less energy because of the photothermal effect. Meanwhile, a control experiment is carried out using pure TiO₂ as the catalyst which hardly absorbs any visible or NIR light. Subsequently, by comparing the energy output curves of both cases, the influence of other factors (including thermal effect of the light source, reactor, water, etc.) can be excluded, therefore, only the contribution of the Au/N—TiO₂ photocatalyst is obtained. As shown in FIG. 5, although the energy output curves are quite fluctuating, an obvious difference can be observed. Integrating the curves and comparing the difference over the reaction period of 1 hour, it is demonstrated that 23.8±1.3% of the solar energy is converted to thermal energy. Consequently, an overall solar conversion (i.e. combined photothermal and photocatalytic conversion) efficiency of 44.1±1.7% is presented in this work.

Having shown that the local electric field can be used to substantially increase the photocatalytic activity of TiO₂-based photocatalysts, the effect of a local electric filed was explored for other photocatalysts, as shown in Table 2 below.

TABLE 2
Effect of local electric fields using SL-MoS₂-based photocatalysts

| | | | Activity |
|---|---|---|---|
| Entry | Photocatalyst | Solvent | (μmol g⁻¹h⁻¹) |
| 1 | Ru-doped SL-MoS₂ | Pure water | 821 ± 33 |
| 2 | Ru-doped SL-MoS₂ | Dead Sea | 4130 ± 127 |
| | | water | |
| 3 | Ru-doped SL-MoS₂ | Natural | 1520 ± 97 |
| | | seawater | |
| 4 | Ru-doped SL- | Pure water | 2977 ± 85 |
| | MoS₂/CeO₂ | | |
| | nanocubes | | |
| 5 | Ru-doped SL- | Dead Sea | 5090 ± 211 |
| | MoS₂/CeO₂ | water | |
| | nanocubes | | |
| 6 | Ru-doped SL- | Natural | 3730 ± 193 |
| | MoS₂/CeO₂ | seawater | |
| | nanocubes | | |

Single layer MoS₂ (SL-MoS₂) based photocatalysts were used, for which detailed characterisations and photocatalytic studies at elevated temperatures are available.¹⁶ As shown in Entry 1-6, the two selected photocatalysts, Ru-doped SL-MoS₂ and Ru-doped SL-MoS₂ supported on CeO₂ nanocubes, both showed increased photocatalytic activities in natural seawater (collected near Bournemouth Pier in Bournemouth, Dorset, UK—Coordinates: N 50.715474°, W 1.876075°) and artificial Dead Sea water, implying the positive effect introduced by the local electric field in the salty environment.

### 3. Effect of the Local Magnetic Field

To enhance the local magnetic flux applied to nano-photocatalyst under external magnetic field, magnetic Fe₃O₄ nanoparticles (NPs) encapsulated in silica were initially synthesised using the method reported in a previous study⁹. HRTEM images confirmed the well-dispersed Fe₃O₄ NPs have been synthesised with a high crystallinity, showing the lattice spacing of 0.298 nm, which corresponds to the (220) plane of Fe₃O₄ structure (FIG. 6a). The Fe₃O₄ NPs with a mean size of 8 nm were shown in FIG. 6b. The size effect of the Fe₃O₄ NPs was also investigated by Mössbauer spectroscopy. The two phases were carefully differentiated and quantified (FIG. 6c). It was noted that a larger particle size gives rise to a higher proportion of Fe₂O₃ due to partial oxidation. Consequently, Fe₃O₄ NPs with a mean size of 8 nm were used for further study. As mentioned before, a previous study has demonstrated that N—TiO₂ showed an outstanding performance for the POWS reaction at elevated temperatures^{17,18}. Therefore, the Fe₃O₄ NPs was then combined with TiO₂, followed by high-temperature ammonia treatment for N-doping, where the designate content of Fe₃O₄ was 20 wt. % (denoted as Fe₃O₄/N—TiO₂-2). HRTEM images and energy dispersive X-ray spectroscopy (EDS) mappings showed that the Fe₃O₄ NPs were mixed in the TiO₂ matrix with a certain degree of aggregation (FIG. 6d and FIG. 6e).

More characterisations were then carried out with XRD, as shown in FIG. 7a. The XRD pattern of pure magnetic Fe₃O₄ NPs gives several characteristic peaks at 20 values of 30.40°, 35.58°, 53.72°, 56.58°, and 62.74°, representing well the single phase crystalline fcc structure. Depth-profiling XPS was performed to investigate the distribution of chemical species of Fe₃O₄/N—TiO₂-2. The sample was etched by an ion-beam for different time periods so as to obtain the chemical information from surface/subsurface to the inner region. A typical XPS survey spectrum shows peaks of N 1s, O 1s, Ti 2p and Fe 2p, as shown in FIG. 7b. Moreover, the Fe 2p peaks show an increasing trend when the sample is sputtered (FIG. 7c), indicating that the Fe₃O₄ NPs are mostly encapsulated in the N-doped TiO₂. EPR was performed at room temperature using X-band (9.4 GHZ) on the N—TiO₂ with and without Fe₃O₄ NPs (FIGS. 7d-7f). The Fe₃O₄ NPs give a very broad and strong resonance signal at a field of around 3150 Gauss, due to the unpaired electrons of the paramagnetic Fe(II) and Fe(III) species and the dipolar interaction between the nanoparticles. The EPR experiments were also carried out on the Fe₃O₄/N—TiO₂-2 photocatalysts before and after the nitrogen doping (FIGS. 7d and 7f), both of which showed a much smaller EPR signal compared with that of the Fe₃O₄ NPs due to the magnetic dilution of the TiO₂. Since the strong and broad Fe₃O₄ NPs signal makes the signal changes of the TiO₂ species undistinguishable, measurements were then performed on pure anatase TiO₂ and N—TiO₂ which was synthesised following the same sol-gel method and nitrogen-doping treatment. Apparently, pure TiO₂ was silent on the EPR, while after nitrogen doping, a peak at a g-factor of 2.003 could be observed, which was attributed to surface oxygen vacancies and the doped N atoms¹⁹. The oxygen vacancies were created during the ammonia treatment, and a previous study has shown that more oxygen vacancies can better harness the visible light and thus facilitate the oxygen evolution reaction^{11,19}. The visible light absorption was also substantially enhanced after nitrogen doping because of the introduction of an extra intraband energy level, which is indicated by UV-vis spectroscopy (FIG. 7g). Apparently, the absorption edge of pristine TiO₂ of around 390 nm was greatly extended after N-doping, and the N—TiO₂ showed strong absorption even in the near infrared (NIR) regime. The bandgaps were derived from the corresponding Tauc plot (FIG. 7h). The magnetic properties of the as-synthesised Fe₃O₄, Fe₃O₄/N—TiO₂-2 and N—TiO₂ were investigated with a SQUID magnetometer, and the magnetisation curves of the materials are shown in FIG. 7i. The saturation magnetisation (Mₛ) values of Fe₃O₄ and Fe₃O₄/N—TiO₂-2 are 43.01 and 16.19 emu g⁻¹. The saturated magnetisation value of Fe₃O₄/N—TiO₂-2 is smaller than Fe₃O₄ NPs because of the inclusion of the N—TiO₂. The as-prepared samples exhibit superparamagnetic feature since the Fe₃O₄ around 8 nm is smaller than the critical size of ca. 20 nm. Due to the lack of magnetic coupling, the materials can be magnetised under an external magnetic field but will not retain residual magnetism upon removal of the external field.

The photocatalytic performances of the as-prepared photocatalysts were then evaluated for the POWS reaction in a closed batch reactor at 270° C. A recent study shows that for N—TiO₂ based photocatalysts, the POWS performance is greatly dependent on the temperature¹¹: the hydrogen evolution rate increases with the temperature and reaches the optimal activity at around 270° C. following the change in water dissociation constant. Systematic EPR study implied that the oxygen mobility and re-generation of the charged oxygen vacancies were greatly facilitated at elevated temperatures to facilitate a rapid photo water splitting¹¹ (FIG. 7d). Initial experiments were performed over N—TiO₂ and Fe₃O₄/N—TiO₂-2 photocatalysts without external magnetic field (all photocatalysts are used after deposition of 1 wt. % of Au via photo-reduction method), both of which showed good performance toward POWS, giving similar hydrogen evolution rates of around 7000 μmol g⁻¹ h⁻¹. The influence of electron transfer between N—TiO₂ and Fe₃O₄ NPs was excluded by introducing an insulated silica layer in between (Fe₃O₄@SiO₂/N—TiO₂), which showed similar POWS activity as that of Fe₃O₄/N—TiO₂-2. The Fe₃O₄ NPs and Fe₃O₄@SiO₂ were both tested alone, showing no detectable hydrogen evolution, which indicates the Fe₃O₄ and SiO₂ have no contribution to the POWS activity under this condition. Subsequently, to study the MFE on the POWS system, external static magnetic field of 180 mT was applied by fixing two permanent magnets in parallel near the reactor during the testing. Excitingly, the POWS activity of Fe₃O₄/N—TiO₂-2 increased to 12,210 μmol g⁻¹ h⁻¹, showing 76% of enhancement. On the contrary, the photocatalytic activity of the N—TiO₂ remains almost the same. The lack of detectable change of N—TiO₂ in response to external magnetic field indicates its weak local field flux density, whereas superparamagnetic Fe₃O₄ nanoparticles can generate much stronger local magnetic flux after magnetisation. To further understand the local magnetic field effects (MFEs) on the POWS system over N—TiO₂ based photocatalysts, a series of Fe₃O₄/N—TiO₂ photocatalysts with different percentages of Fe₃O₄ NPs were synthesised via the same sol-gel method. The Fe₃O₄ NPs content of each sample was calculated to be 10%, 20%, 30% and 40%, respectively, which are accordingly denoted as Fe₃O₄/N—TiO₂-1, Fe₃O₄/N—TiO₂-2, Fe₃O₄/N—TiO₂-3, and Fe₃O₄/N—TiO₂-4. The M-H curve of the Fe₃O₄/N—TiO₂ photocatalysts in FIG. 7i exhibited superparamagnetic nature, in which case a strong local magnetic field could clearly be induced by the external field, while no obvious induced magnetisation was detected over N—TiO₂. The photocatalytic performance shows a decreasing trend as the field strength is reduced (FIG. 8a). Similarly, FIG. 8b shows the saturated magnetisation value varies with the Fe₃O₄ NPs content. The POWS activities were then tested at 270° C. as well under visible light irradiation with an external magnetic field of 180 mT. FIG. 8c clearly indicates that the magnetic photocatalysts become more sensitive to the external magnetic field as the content of the Fe₃O₄ NPs increasing.

Clearly, the POWS activity strongly depends on the intensity of the local magnetic field induced by the superparamagnetic NPs in the presence of an external magnetic field, implying the dramatic MFEs on the POWS systems. Work has also been undertaken on the commercially available P25 TiO₂ to simplify the catalyst design. P25 consists of ca. 80% anatase and 20% rutile, which has been widely used in various photocatalytic systems. It was doped with nitrogen via ammonia treatment, and then combined with iron oxide by ultra-sonication and calcination. The as-obtained photocatalyst contains 40% of Fe₃O₄ NPs, the same as that in the Fe₃O₄/N—TiO₂-4. Excitingly, the simple mixture of N-doped P25 and Fe₃O₄ NPs results in a significant enhanced POWS performance in the external magnetic field (180 mT) as well, making such magnetic field promoted system more practical for further application.

Time-resolved photoluminescence (TRPL) was then used to investigate the charge separation process with and without the magnetic field. Both Fe₃O₄/N—TiO₂-2 and N—TiO₂ showed similar exciton lifetimes without external magnetic field, while the exciton lifetime of Fe₃O₄/N—TiO₂-2 was prolonged substantially when the magnetic field existed, and that of the pure N—TiO₂ remained unchanged. Such a difference in the response to an external magnetic field coincided well with what was observed in the POWS activity tests. Subsequently, further TRPL experiments showed that the exciton lifetime of Fe₃O₄/N—TiO₂-2 increases with the magnetic field strength, confirming the exciton lifetime changes in response to the applied magnetic field. This induces stronger local magnetic field strengths and supresses the charge separation process (FIG. 8e). A series of Fe₃O₄/N—TiO₂ with varied Fe₃O₄ contents were then tested. Apparently, all samples showed similar TRPL spectra without an external magnetic field (FIG. 8d); whilst, when measured in a magnetic field of 180 mT, the exciton lifetime was prolonged more substantially with higher content of Fe₃O₄ (FIG. 8f), which is in accordance with the magnetisation experiments (FIG. 8b) and the POWS activity tests (FIG. 8c). The above observations indicate that the charge separation process is dominated by the locally induced magnetic field, therefore the N—TiO₂ alone showed no significant response to the magnetic field. In addition, the MFEs become more substantial when the external magnetic field is stronger, because stronger external fields induce stronger local magnetic fields as shown in the magnetisation experiments (FIG. 8b). This could also explain why for a fixed external field, samples that contain more Fe₃O₄ show a larger response to the field. It is known that charge bodies in motion can be affected by Lorentz force by an external magnetic field, and the excited electrons and holes of the N—TiO₂ coated on the Fe₃O₄ NPs will experience the Lorentz forces in opposite direction with a strong local magnetic field to account for their longer recombination lifetimes.

Concerning the potential of practical applications of a POWS system, QE and STH efficiency are widely recognised as parameters that can be directly compared when evaluating different POWS systems. QE is the ratio of the number of H₂ molecules evolved to the number of photons of a given energy that shines on the photocatalyst. So, it is normally measured at a certain wavelength rather than a wide spectrum, so as to understand the behaviours of a photocatalytic system at different wavelengths. While STH is a standardised index focusing on the overall energy conversion efficiency from the solar energy to chemical energy. In this work, QEs of Fe₃O₄/N—TiO₂-4 were evaluated at different wavelengths using a 300W Xe lamp installed with bandpass filters of different wavelengths, and STH was tested under the irradiation of simulated AM 1.5G solar light generated by a VeraSol solar simulator with the power of 100 mW cm⁻² (1 Sun). FIG. 9a clearly shows that N—TiO₂, although shows good QE at 437 nm, remains uninfluenced by the use of external magnetic field. The results shown in FIG. 9b present an impressive QE of 77.3% at 437 nm without external magnetic field over Fe₃O₄/N—TiO₂-4, while the QEs dropped at longer wavelengths. Excitingly, when the external magnetic field was applied, the QEs of each wavelength increased to different extent, giving an extraordinary QE of 88.7% at 437 nm, and the QE at 750 nm was increased by more than 3 times, as shown in FIG. 9b. Moreover, a QE of ca. 20% can be obtained even at NIR regime of 1000 nm. Additionally, using Fe₃O₄/N—TiO₂-4 photocatalyst, an extraordinary STH of 12.2% was also achieved from such POWS system in a magnetic field of 180 mT. Stability of the Fe₃O₄/N—TiO₂-4 photocatalyst was also evaluated by recycling the catalysts for 5 times, which showed no obvious change of the photocatalytic activities (FIG. 9c).

### 4. Effect of Combining the Local Electric Field and the Local Magnetic Field

More studies on the magnetic photocatalyst Fe₃O₄/N—TiO₂-4 have been carried out, as shown in Table 3 below.

TABLE 3
Effect of combining local electric and magnetic fields

| | | Magnetic | | Activity |
|---|---|---|---|---|
| Entry | Photocatalyst | field | Solvent | (μmol g⁻¹h⁻¹) |
| 1 | Fe₃O₄/N—TiO₂-4 | / | Pure water | 6825 ± 262 |
| 2 | Fe₃O₄/N—TiO₂-4 | 180 mT | Pure water | 21230 ± 520 |
| 3 | Fe₃O₄/N—TiO₂-4 | 180 mT | 0.6M | 26305 ± 417 |
| | | | NaCl(aq.) | |
| 4 | Fe₃O₄/N—TiO₂-4 | 180 mT | Dead Sea | 36370 ± 733 |
| | | | water | |
| 5 | Fe₃O₄/N—TiO₂-4 | 180 mT | Natural | 27170 ± 438 |
| | | | seawater | |

Local magnetic field effects and ionic effect were combined together, and clearly, in the presence of a magnetic field of 180 mT, the photocatalytic activity increased with the ionic strength: it showed the lowest activity in pure water (Entry 2) and highest in the artificial Dead Sea water (Entry 4, the ionic strength is around 6 mol L⁻¹). The global average ionic strength of seawater is about 0.6 mol L⁻¹, thus a NaCl aqueous solution of 0.6 mol L⁻¹ was used for the photocatalytic water splitting reaction. Also, natural seawater was collected near the Bournemouth Pier (Bournemouth, Dorset, UK. Coordinates: N 50.715474°, W 1.876075°) and used after filtration. As shown in Entry 3 and 5, both exhibited similar photocatalytic activities. These results indicate that the local electric field effect in salty water can be applied well to the magnetic photocatalysts, such as Fe₃O₄/N—TiO₂-4.

### 5. Lanthanide-Doped Perovskite Oxynitrides

### 5.1. Introduction

Perovskite-type oxynitrides have recently been investigated as potential photocatalysts for water splitting. These oxynitrides have the formula: AB(O,N)₃ (A=Ca, Sr, or Ba; B=Nb and Ta). The BaTaO₂N perovskite oxynitride (BTON) is a promising candidate for the photocatalytic overall water splitting (POWS) reaction due to their strong visible light absorption along with their thermodynamic feasibility for the redox reactions. In addition, BTON is stable in aqueous solution and is nontoxic, making it more desirable as a photocatalyst.

For further improving the catalytic performance and modifying the physicochemical properties of BTON, lanthanide series elements (Ln) have been doped into BTON. The cation doping has been considered an effective technique for improving the photocatalytic performance of semiconductor materials. In this work, it has been discovered that the Ln-doping could also lead to ferromagnetism in the resulted materials, which leads to facilitated charge carrier separation and enhanced photocatalytic performance. In another word, the magnetic field effects could be exerted by the Ln-doping without the presence of any external magnetic field. Furthermore, the resulted materials showed remarkable photocatalytic performance and stability toward the POWS reaction in seawater.

### 5.2. Experimental Methods

### Flux-Synthesis of BTON and Ln-BTON

The undoped and lanthanide-doped BTON were prepared by flux-assisted solid-state synthesis. For undoped BTON, barium carbonate (BaCO₃, 0.605 mmol, 119.4 mg) and tantalum (V) oxide (Ta₂O₅, 0.2745 mmol, 121.3 mg), along with potassium chloride (KCl, 4.96 mmol, 368.8 mg) as the flux agent, were ground together by hand for 10 minutes. The resulting solid was then placed in a quartz boat in a tube furnace. The solid was heated at a rate of 5° C. min⁻¹ to 900° C. and calcined under a flow of ammonia for 15 hours to produce the oxynitride. After NH₃ treatment, the powder product was washed with deionised water to remove any leftover KCl, followed by drying under vacuum at 60° C. overnight.

The lanthanide-doped BTON were prepared by the addition of the amount of LnₓO_{y} that corresponds to 0.06 mmol of Ln ions (Ln=La, Ce, Pr, Nd, Sm, Eu, Gd, Tb, Ho, Tm, Yb, Lu) with LnₓO_{y}═La₂O₃ (0.03 mmol, 9.8 mg), CeO₂ (0.06 mmol, 10.3 mg), Pr₆O₁₁ (0.01 mmol, 10.2 mg), Nd₂O₃ (0.03 mmol, 10.1 mg), Sm₂O₃ (0.03 mmol, 10.5 mg), Eu₂O₃ (0.03 mmol, 10.6 mg), Gd₂O₃ (0.03 mmol, 10.9 mg), Tb₄O₇ (0.015 mmol, 11.2 mg), Ho₂O₃ (0.03 mmol, 11.3 mg), Tm₂O₃ (0.03 mmol, 11.6 mg), Yb₂O₃ (0.03 mmol, 11.8 mg), and Lu₂O₃ (0.03 mmol, 11.9 mg). This aimed to synthesise Ln-BTON with the following approximate stoichiometry: Ln_{0.1}Ba_{0.9}Ta(O,N)₃. The remaining synthesis steps were kept the same as for undoped BTON. For the syntheses of Gd_{0.2}Ba_{0.8}Ta(O,N)₃ and Gd_{0.4}Ba_{0.6}Ta(O,N)₃, the above procedure was followed but with 0.06 mmol (21.8 mg) and 0.12 mmol (43.6 mg) of Gd₂O₃, respectively.

### Hydrothermal Syntheses of Eu-BTON

This method involves a hydrothermal synthesis of a barium tantalum oxide precursor followed by addition of the lanthanide oxide and KCl and then nitridation in an NH₃ flow at high temperatures. Barium hydroxide monohydrate (Ba(OH)₂·H₂O, 3.0 mmol, 568.1 mg) was dissolved in 20 ml of deionised water in a 50 ml PTFE-lined autoclave. N₂ was bubbled through the mixture for five minutes under stirring with an electric stirrer bar to remove the dissolved air. Tantalum oxide (Ta₂O₅, 1.36 mmol, 602.6 mg) was then added, and the mixture was stirred for a further five minutes. The autoclave was sealed, added to a furnace which was heated to and maintained at 200° C. for 24 hours, and then allowed to cool to room temperature naturally. The resulting white solid sample was separated from the solution by centrifugation, washed with ethanol followed by water, and then dried under vacuum at 60° C. overnight.

For the synthesis of Ln_{0.1}BTON, 100 mg of the resulting solid was then ground for 10 minutes with Ln₂O₃ (Ln=Eu or Gd, 0.018 mmol, 6.4 mg or 6.5 mg respectively) and KCl (2.97 mmol, 221.4 mg) and nitrided under a flow of NH₃ at 1000° C. for two hours. The samples were labelled as HA Ln-BTON. For the syntheses of HA Gd_{0.2}Ba_{0.8}Ta(O,N)₃ and HA Gd_{0.4}Ba_{0.6}Ta(O,N)₃, the above procedure was followed but with 0.036 mmol (13.0 mg) and 0.072 mmol (26.0 mg) of Gd₂O₃, respectively.

### Loading of Noble Metal Nanoparticles

The activity upon loading of all the metal nanoparticles was assessed by loading them onto flux-synthesised Eu-BTON using a photo-deposition method. Pt nanoparticles were subsequently loaded onto HA Eu-BTON, HA Gd-BTON, flux-synthesised Gd_{0.2}Ba_{0.8}TON and Gd_{0.4}Ba_{0.6}TON, HA Gd_{0.2}Ba_{0.8}TON, and HA Gd_{0.4}Ba_{0.6}TON.

The noble metals used were Au, Pt, Ru, Pd, and Ag. Pre-made solutions containing 2 mg of Au and Pt per ml (HAuCl₄ and H₂PtCl₆ respectively) were used. A solution containing 0.5 mg Ru per ml was made by adding 51.4 mg of RuCl₃ to a 50 ml volumetric flask, topping it up to the line with deionised water and inverting for 5 minutes. A solution containing 0.5 mg Pd per ml was made the same way with 41.6 mg PdCl₂ and a solution containing 2 mg Ag per ml was made the same way with 157.4 mg AgNO₃.

100 mg of the photocatalyst was added to a 250 ml round-bottomed flask along with 30 ml deionised water, 30 ml methanol and the volume of noble metal precursor containing 1 mg of metal ions (0.5 ml for Au, Pt, and Ag, and 2 ml for Ru and Pd). The mixture was sonicated for five minutes, a stirrer bar was added, and the opening of the flask was covered. The flask was then irradiated under a 300W UV lamp (Helios Italquartz S.R.L.) for one hour whilst stirring. The mixture was washed with water and the resulting solid was then dried in a 60° C. oven overnight.

Upon irradiation, the photo-generated electrons in the CB reduce the metal ions, forming neutral metal nanoparticles which are deposited on the surface of the photocatalyst. The methanol acts as a sacrificial reagent and is oxidised by the photo-generated holes in the VB, producing CO₂ and other products.

### 5.3. Results

### Lanthanide Series Doping

The lanthanide-doped barium tantalum oxynitrides were synthesised by a one-pot flux synthesis method that involved nitriding under NH₃ flow for 15 hours at 900° C. The aim was to produce oxynitrides with the following approximate stoichiometries: Ln_{0.1}Ba_{0.9}Ta(O,N)₃.

The structure of the perovskites was initially investigated using PXRD. PXRD patterns of the samples were compared against the literature pattern for BTON; these all had the same characteristic peaks (FIG. 10) which confirmed that all the Ln-BTONs synthesised had retained the perovskite structure of undoped BTON.

### Water Splitting Activity of Ln-BTON

The Ln-BTON materials have the bandgap energy of 1.65-1.82 eV as estimated from the UV-Vis diffuse reflectance spectra (FIG. 11).

In order to test the water splitting activity of the Ln-BTONs, photocatalytic tests were carried out by measuring the amount of H₂ produced over two hours whilst the reaction mixture was irradiated by a solar simulator (AM 1.5G) and heated to 270° C.

All the lanthanide-doped perovskites showed higher photocatalytic activity than the undoped BTON (see FIG. 12). Of the lanthanide-doped perovskites, Gd-BTON was the most active, with an H₂ evolution rate approximately 1.6 times that of undoped BTON. The POWS activity was then evaluated in natural seawater (collected from Bournemouth, UK). As indicated in FIG. 3, for all samples, the H₂ evolution rate from the POWS reaction increase significantly to different extents in natural seawater, among which the Gd-BTON shows the highest rate of 3086±68 μmol g⁻¹ h⁻¹ in natural seawater.

### Magnetic Property of Ln-BTON

In order to investigate the paramagnetic properties of the photocatalysts, superconducting quantum interference device (SQUID) measurements were carried out on the lanthanide-doped oxynitrides (see FIG. 13). The slopes of the linear parts in the high field region were then used to calculate the magnetic moments of the samples. These values correspond to those typically observed for the Ln³⁺ ions, which mostly follow the values calculated from the Landé equation.

The linear paramagnetic component of the M-H curve was then subtracted to leave any ferromagnetic component. It was found that all of the doped oxynitrides (except for La and Lu) show unique ferromagnetic properties at room temperature to varying degrees and show residual magnetisation upon removal of the external magnetic field. The magnetisation of a mixture of Gd₂O₃ and BTON was also measured as a control—this mixture showed no ferromagnetic behaviour, indicating that the ferromagnetism is caused upon doping of the lanthanide ion. The ferromagnetic strength of the doped perovskites was also found to be proportional to the spin quantum number of the Ln³⁺ ion, with Gd-BTON showing the greatest ferromagnetic strength (see FIG. 14).

The above trend of ferromagnetic strength matches that of the photocatalytic activities of the Ln-BTON samples. As Gd-BTON shows the highest ferromagnetic behaviour, this should lead to the greatest water splitting activity, which is indeed shown by Gd-BTON. Therefore, this ferromagnetism introduced by the Ln-doping is responsible for the increased water splitting activity.

In order to investigate the lifetime of the charge carriers within the photocatalysts, time-resolved photoluminescence measurements were carried out for both the undoped BTON and the Ln-BTON samples. The resulting spectra were then used to calculate the lifetime of the charge carriers (FIG. 15a). As shown in FIG. 15b, the lifetime of the charge carriers is proportional to the activity of the photocatalyst.

The trend shown by the lifetime of the charge carriers is also similar to that of the ferromagnetic behaviour. This is because the electron spins tend to align in the same direction in the ferromagnetic Ln-BTON materials, resulting in a spin-polarised environment. The spin-polarisation then suppress the recombination of the charge carriers, leading to prolonged charge carrier lifetime.

### Noble Metal Cocatalysts

Gd-BTON was then loaded with 1 wt. % of Au, Ag, Pt, Pd, and Ru nanoparticles using a photo-deposition method, respectively, as the surface co-catalyst.

The activity of the noble metal-loaded photocatalysts was measured using gas chromatography. The results showed that Pt was the most effective cocatalyst, with a 50% increase in H₂ evolution compared with the bare Gd-BTON (see FIG. 16).

### Doping Concentration Study

The results demonstrate that ferromagnetic properties are introduced into BTON upon Ln-doping, which facilitates the local alignment of electronic spins, resulting in the prolonged charge carrier lifetime and the enhanced POWS performance. Therefore, the doping concentration of Gd in the Gd-BTON was increased. The previously discussed Gd-BTON has a chemical formula of Gd_{0.1}Ba_{0.9}TaO₂N. BTON samples Gd_{0.2}Ba_{0.8} TaO₂N and Gd_{0.4}Ba_{0.6} TaO₂N were successfully synthesised using a flux-assisted method. The charge carrier lifetime and the POWS activity were evaluated. The lifetime was prolonged to 26.4 ns and 37.9 ns, respectively, compared with 14.2 ns of Gd_{0.1}Ba_{0.9}TaO₂N. The POWS activity in pure water was improved significantly as well, giving a H₂ evolution rate of 2627 and 3064 μmol g⁻¹ h⁻¹, respectively, compared with 1926 μmol g⁻¹ h⁻¹ of Gd_{0.1}Ba_{0.9}TaO₂N. Subsequently, the POWS activity was evaluated in natural seawater, and the activity was improved by about 50% for each catalyst (FIG. 17).

### Optimisation of Synthesis Method

The synthesis method of the perovskite was altered in order to reduce the size of the particles, so that a higher surface area could be obtained. The previous synthesis method was a one-pot, flux-assisted solid-state synthesis. The new synthetic method was then used, which involved an initial hydrothermal synthesis of a barium tantalum oxide followed by flux-assisted nitridation to form the lanthanide-doped oxynitride. Gd_{0.4}Ba_{0.6}TaO₂N was successfully synthesised using this hydrothermal method, denoted as HT-G4B6. This catalyst was also evaluated for the POWS reaction, and the 1 wt. % HT-G4B6 finally showed a H₂ evolution rate of 8628 and 16593 μmol g⁻¹ h⁻¹ in pure water and natural seawater, respectively.

### 6. Conclusion

In conclusion, the POWS performance can be greatly enhanced by the local magnetic/electric field. By mixing the N—TiO₂ photocatalyst with superparamagnetic Fe₃O₄ NPs under an external magnetic field, strong local magnetic flux can be induced, which has been shown here to facilitate the charge separation process and lead to improved POWS activity. The enhancement is closely related to the strength of the local magnetic flux, which can be influenced by the external magnetic field and the concentration of the Fe₃O₄ NPs in the photocatalyst. Moreover, the local electric field was systematically studied by using salty solution instead of pure water in the POWS reaction. Starting with the simple NaCl aqueous solutions, it was found that the activities increased with the concentration of NaCl. Other neutral solutions showed similar effects. With the help of TRPL technique, such enhancement of photocatalytic activities was correlated with the exciton lifetimes of the photocatalyst, which were greatly prolonged by the ionic species. Enlightened by such results, simulated seawaters were made in lab and tested in the POWS system at elevated temperature. Excitingly, extraordinary POWS activities and QEs were therefore obtained in the simulated Dead Sea water over Au/N—TiO₂ photocatalyst at 270° C. It is believed the study of the local magnetic/electric field in this work will contribute to the better utilisation of solar energy and the rational design of other photocatalytic systems.

### PART B

### 1. Materials and Methods

### Materials

The reagents used in this work are the following: titanium butoxide (Ti(OC₄H₉)₄, 99.99% trace metal basis, Sigma-Aldrich); hydrofluoric acid (ACS reagent, 48%, Sigma-Aldrich); hydrogen tetrachloroaurate trihydrate (reagent grade, Sigma-Aldrich); Cobalt nitrate hexahydrate (reagent grade, Sigma-Aldrich); Nickel chloride hexahydrate (reagent grade, Sigma-Aldrich); Palladium nitrate dehydrate (reagent grade, Sigma-Aldrich); Chloroplatinic acid (H₂PtCl₆, reagent grade, Sigma-Aldrich); Methanol (anhydrous, ≥99.8% (HPLC), Sigma-Aldrich); Ammonia gas (anhydrous, BOC); Argon gas (99.99%, BOC); Helium gas (99.99%, BOC); Nitrogen gas (99.99%, BOC)

Synthesis of N-doped TiO₂ (N—TiO₂) Photocatalysts

The synthesis of the morphology-controlled TiO₂ nanocrystals was adopted from the literature:²⁰ 5.0 mL of Ti(OC₄H₉)₄ was mixed with 0.6 mL of hydrofluoric acid (48 wt. %) in a 50-mL Teflon-lined autoclave and subsequently heated to 180° C. at a rate of 5° C. min⁻¹. The temperature was kept at 180° C. for 24 h. After the hydrothermal process, the as-obtained white precipitate was washed with ethanol and deionised water for three times, respectively, and then dried in an oven at 80° C. overnight. For the N-doping, 200 mg of the facet-controlled TiO₂ was placed in a quartz boat which was then transferred to a tubular furnace. The sample was then heated to 600° C. at a rate of 5° C. min⁻¹ and kept for 2 hours under an NH₃ flow (200 mL min⁻¹), after which it was allowed to cool down naturally and the N—TiO₂ powder was collected. The N—TiO₂ photocatalyst was loaded with different metal nanoparticles as the H₂ evolution co-catalyst via a photo-deposition method afterwards, which is described below.

### Photo-Deposition of Co-Catalysts

Different metal nanoparticles were loaded onto the morphology-controlled N—TiO₂ nanocrystals via a photo-deposition method adopted from the literature:^{21,22} 100 mg of the N—TiO₂ powder was dispersed in 80 mL of methanol aqueous solution (30 vol. %), after which a solution containing the desired metal precursor was added into this suspension under continuous magnetic stirring, followed by irradiation (300 W, Xe arc lamp) for 30 min. Then the suspension was filtered, washed with deionised water, and finally dried at 80° C. overnight.

### X-Ray Diffraction (XRD)

X-ray diffraction spectroscopy was all performed on a Bruker D8 Advance diffractometer with LynxEye detector and Cu Kα1 radiation (λ=1.5406 Å). Each measurement was scanned at a 2θ range of 5-90°.

### Raman Spectroscopy

Raman spectra were recorded on a Perkin Elmer Raman Station 400 F spectroscopy system. Samples were loaded in a capillary and fixed on the sample platform. The measurements were performed at 50% laser power and the exposure time was 5 seconds for each scan and 4 scans were adopted for each measurement.

### Ultraviolet-Visible Diffuse Reflectance Spectroscopy (UV-Vis DRS)

Ultraviolet-visible diffuse reflectance spectroscopy (UV-vis DRS) were obtained from a Shimadzu UV-2600 UV-visible-infrared spectrometer at room temperature. 50±5 mg of each sample was loaded and pressed onto a sample holder and UV-vis spectra were recorded within the wavelength range of 200-1500 nm.

### Continuous-Wave Electron Paramagnetic Resonance (CW-EPR) Spectroscopy

CW-EPR spectra were recorded on an X-band (9.4 GHZ) Bruker EMX EPR spectrometer in Centre for Advanced Electron Spin Resonance (CAESR), University of Oxford. All measurements were carried out at 293 K. All X-Band spectra were collected over a magnetic field range of 1000 Gauss and 10 scans were obtained for each measurement. Signal intensity vs. electron spin numbers were calculated from the double integration of a defined peak range of the spectra.

### Time-Resolved Photoluminescence (TRPL) Spectroscopy

Photoluminescence spectra and corresponding excitonic lifetimes were obtained from a bespoke micro-photoluminescence setup, in which a Ti-Sapphire laser (λ=266 nm, pulse duration=150 fs, repetition rate=76 MHZ) was directed onto the sample. Time-resolved measurements were performed under a pulse-picking mode in order to tune the interval between two consecutive measured laser pulses (100 ns), which allowed the excited charge carriers to fully relax to the ground state (i.e., signal decaying to zero) before next pulse arrived. The spectrometer was used as a monochromator before passing the selected signal to an avalanche photodiode (APD) detector with an instrument resolution of ˜50 ps connected to a time-correlated single-photon counting module.

The exciton lifetime is obtained by fitting corresponding background-corrected PL spectra with a bi-exponential decay function in the form y=A₁e^{-x/t}^{₁}+A₂e^{-x/t}^{₂}+y₀. Errors in the fitting were determined using a least square method.

### Scanning Transmission Electron Microscopy (STEM)

Atomic-resolution STEM-HAADF images were obtained on a double spherical aberration-corrected S/TEM FEI Titan G2 60-300 at 300 kV with a field emission gun. The probe convergence angle on the Titan electron microscope was 24.5 mrad, and the angular range of the HAADF detector was from 79.5 mrad to 200 mrad.

### Performance Evaluation of POWS Reaction at Elevated Temperatures

The POWS reaction was carried out in a 20-mL stainless steel batch reactor equipped with two quartz windows with an illuminated area of 0.785 cm² (10 mm in diameter and 18 mm in thickness each). In a typical experiment, 20 mg of catalyst was added to 5 mL of deionised water (or natural seawater) in a glass lining (20 mm i.d.×24 mm o.d.×52 mm height) under magnetic stirring (750 rpm) as a particulate suspension, then the batch reactor was purged with continuous Ar gas flow for 5 min after well-sealed to remove the dissolved O₂ in water. Then the batch reactor was pressurised with 6 bar of inert Ar gas. The reactor would then be allowed to heat up to certain elevated temperature with its saturated water vapour pressure. VeraSol solar simulator (AM 1.5G, 100 mW cm⁻², 1 sun) was then used to provide the simulated solar irradiation through the silica windows. The batch reactor was cooled down naturally to room temperature after reaction and the amounts of O₂ and H₂ were measured by gas chromatograph (GC) equipped with two thermoconductivity detectors (TCD) with He and N₂ as carrier gas, respectively, for better sensitivity. GC analysis was also carried out before reactions to make sure the air and dissolved O₂ were completed removed. The natural seawater used in this work was collected near the Bournemouth Pier (Bournemouth, Dorset, UK. Coordinates: N 50.715474°, W 1.876075°) and used after filtration. The STH conversion efficiency can be calculated by the following equation:

$$STH ( \% ) = \frac{Evolved hydrogen amount \times {Δ}_{r} {G}_{m}^{θ} ( 543 K )}{P \times S \times t} \times 100 \% \qquad Eq . S1$$

where P is the power of solar irradiation (100 mW cm⁻²), and S is the illuminating area (0.785 cm²), t is the time of reaction.

The apparent QE was measured in the same reactor following the same procedure: the POWS performance was evaluated by adding a certain amount of photocatalyst which contained 20 mg of N—TiO₂ to 5 mL of Milli-Q H₂O under vigorous magnetic stirring (600 rpm), then the batch reactor was this time irradiated by a 300-W Xenon lamp (Newport) equipped with band-pass filters of 385±20, 440±10, 575±25, 650±20, 750±20 and 850±20 nm, respectively. Generally, the incident photons were corrected by subtracting the scattered and transmitted light from the incident light: there were two silica windows parallelly equipped on the both sides of the batch reactor, which were facing to each other. Thus, the incident light was firstly measured using a light metre in the centre of the batch reactor; and then the scattered and transmitted light were also measured outside the opposite window when the reaction suspension was present. Subsequently, the light coming out of the reactor was subtracted from the incident light, and the attenuation in the light intensity was worked out. The light inside the reactor might also have been scattered by the photocatalyst particles, but most of it would be reflected by the stainless-steel surface and finally was absorbed by the photocatalyst. Subsequently, the relevant number of incident photons was calculated from the irradiation powers at each wavelength. The apparent QE can be calculated by using the equation:

$$QE ( \% ) = \frac{Number of evolved {H}_{2} molecules \times 2}{Number of incident photons} \times 100 \% \qquad Eq . S2$$

QE and STH measurements were repeated for at least 3 times and the average values and standard deviations were calculated. Examples of QE and STH calculation are given in Supplementary Note 2.

### Evaluation of the Photothermal Conversion Efficiency

The photothermal effect was evaluated by precisely monitoring the heating process of the POWS reaction at elevated temperatures. Details of the POWS reaction was demonstrated above, and the heating process was precisely controlled by a Parr thermo-controller under the proportional-integral-derivative (PID) control mode and visualised by a SpecView-3 software (FIG. 18). The photocatalytic system is wrapped by quartz wool and aluminium foil to minimise the heat loss. The solar simulator was used to provide the simulated solar irradiation when the reactor reached the required temperature. For the capture of IR light in solar spectrum, 20 mg of Cs_{0.33}WO₃ nanoparticles were added to the photocatalyst suspension before the reaction, as specified herein.

Control experiments were carried out by using pure water without any photocatalyst or IR absorber. The batch reactor was then heated to the required temperature under the PID control mode, and the simulated solar irradiation was applied likewise. The light absorption of pure water is negligible in this system, considering the absorption thickness is very small (around 2 cm), and it does not show any observable H₂ evolution under the simulated solar irradiation in the studied temperature range. Upon the simulated solar irradiation, the Pt/N—TiO₂ photocatalyst absorbs the photons up to 873 nm according to the Tauc plot, and then converts a part of the photon energy into thermal energy, which is then stored in the superheated steam. Therefore, the thermo-controller will provide less energy because of this photothermal effect, compared with the situation in which pure water is used. The output power curves plotted against time could then be obtained, and by integrating the curve across the reaction time, the total output energy of the heaters could be worked out. By comparing the total energy in the cases of Pt/N—TiO₂ suspension and pure water, it is possible to obtain how much solar energy is converted to heat by the Pt/N—TiO₂ catalyst through the photothermal effect up to 873 nm over the reaction period (0-120 min), and meanwhile, the influence of other factors (such as the thermal effect of the light source, reactor and water, etc.) can be excluded. The control experiment was carried out within the same day as the experiment of Pt/N—TiO₂, in order to minimise the changes of the environmental temperature and the working conditions. Each experiment was repeated for 5 times to reduce the experimental error. It is noted that the change of the heat capacity due to the addition of the photocatalyst nanoparticles is negligible in the system described herein (m_{water}=10 g, c_{water}=4.2 J g⁻¹ K⁻¹; m_{TiO2}: 0.025 g, c_{TiO2}=0.683 J g⁻¹ K⁻¹). The solar-to-heat conversion efficiency can be calculated using the following equation:

$${η}_{Thermal} = \frac{E ( Water ) - E ( \text{Pt/N} - {TiO}_{2} )}{P \times S \times t} \times 100 \% \qquad Eq . S3$$

where E is the energy provided by the electrical heaters for maintaining the reaction temperature; P is the power density of the simulated solar irradiation (100 mW cm⁻²); S is the irradiation area; t is the reaction time.

For the measurements in the presence of Cs_{0.33}WO₃ nanoparticles, the evaluation procedure was the same. Cs_{0.33}WO₃ nanoparticles are able to absorb light ranging from 850 nm to 2500 nm (near infrared, NIR) and exert an additional photothermal effect.

The evaluations of the STH conversion efficiency and the photothermal effect were also performed using another experimental set-up (FIG. 18b), following the same procedure as demonstrated above, to reassure that the above evaluations of this POWS system at elevated temperatures are reliable and repeatable.

### Supplementary Note 1

The photothermal conversion efficiency was calculated using the Eq. S2. Taking one measurement as an example (270° C., in the reactor shown in FIG. 18a):

$$Total solar energy input = 100 mW \cdot {cm}^{- 2} \times 0.7 \; 85 {cm}^{2} \times 7200 s = 565.2 J$$

$${η}_{Thermal} ( \% ) = \frac{Measured photothermal energy}{Total solar energy input} = \frac{310.3 J}{565.2 J} \times 100 \% = 54.9 \%$$

The measurements were repeated for 5 times, resulting in an average η_{Thermal} of 54.9±2.5%. Subsequently, the resulted superheated steam can be used in a steam-turbine generator for electricity generation, which is followed by water electrolysis for further hydrogen evolution (FIG. 19b). Thus, this additional hydrogen evolution is also evaluated in this work. The achievable efficiencies of the steam-turbine generator and the PEM electrolyser are obtained from literature, which are 40% and 72%, respectively.²³⁻²⁶ Therefore, the additional solar-to-hydrogen conversion efficiency (denoted as η_{STH,PT}) can be evaluated as follows:

$${η}_{STH , PT} = {η}_{Thermal} \times 40 \% \times 72 \% = 15.8 \pm 0.7 \% \\ {η}_{STH , overall} = {η}_{STH , PC} + {η}_{STH , PT} = 22.1 \pm 1. \%$$

The detailed evaluation of η_{STH,PC} is given in Supplementary Note 2. The other efficiencies at different experimental conditions have been evaluated using the same method, as summarised in Table 4.

### Supplementary Note 2

Evaluation of the photocatalytic solar-to-hydrogen (STH) conversion efficiency (denoted as η_{STH,PC}). The POWS reaction carried out at 270° C. has been shown as an example in this section. As discussed herein, the partial pressures of the produced H₂ and O₂ change as the reaction proceeding. Obviously, the reaction was not taking place at the thermodynamically standard condition. Therefore, the free energy at our operating conditions has been evaluated firstly:

### 1. Calculation of the Gibbs Free Energy at 298 K and 101.325 kPa

For the reaction:

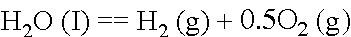

The standard enthalpy of reaction is:

$${Δ}_{r} {H}_{m}^{θ} = 0 + 0.5 \times 0 - ( - 286 ) = 286 \text{kJ/} mol$$

The standard entropy change of reaction is:

$${Δ}_{r} {S}_{m}^{θ} = 130.684 + 0.5 \times 205.138 - 69.91 = 163.3 \; 43 \text{J/} ( mol \cdot K )$$

According to the equation of Gibbs free energy:

$${Δ}_{r} {G}_{m}^{θ} = {Δ}_{r} {H}_{m}^{θ} - T {Δ}_{r} {S}_{m}^{θ}$$

The standard Gibbs free energy at 298 K is:

$${Δ}_{r} {G}_{m}^{θ} = 286 - 298 \times 163.343 \times 1 {0}^{- 3} = 237 kJ / mol$$

### 2. Calculation of the Gibbs Free Energy at 543 K and 101.325 kPa

According to the Van't Hoff equation:

$$\frac{d ln K}{d T} = - \frac{Δ {H}^{θ}}{{RT}^{2}}$$

Therefore,

$$ln \frac{{K}_{2}}{{K}_{1}} = - \frac{Δ {H}^{θ}}{R} ( \frac{1}{{T}_{2}} - \frac{1}{{T}_{1}} )$$

Also, because

$${Δ}_{r} {G}_{m}^{θ} = - RT ln K$$

Then

$$- \frac{{Δ}_{r} {G}_{m}^{θ} ( {T}_{2} )}{{RT}_{2}} + \frac{{Δ}_{r} {G}_{m}^{θ} ( {T}_{1} )}{{RT}_{1}} = - \frac{Δ {H}^{θ}}{R} ( \frac{1}{{T}_{2}} - \frac{1}{{T}_{1}} )$$

Thus, the Gibbs free energy at 543 K and 101.325 kPa can be calculated:

$${Δ}_{r} {G}_{m}^{θ} ( 543 K ) = 1 96.73 kJ / mol$$

The reactant at elevated temperatures in the system described herein is still liquid water under the saturated vapour pressure at each given temperature. Thus, the phase change from liquid water to water vapour is not considered, since it is not involved in the reaction.

### 3. Correction of the Gibbs Free Energy for the Partial Pressures

According to the Van't Hoff isotherm:

$${Δ}_{r} {G}_{m} = {Δ}_{r} {G}_{m}^{θ} + RT ln Q$$

where ΔᵣGₘ is the Gibbs free energy of reaction under non-standard states at temperature T;

$${Δ}_{r} {G}_{m}^{θ}$$

is the Gibbs free energy of the reaction at T and 101.325 kPa; Q is the thermodynamic reaction quotient.

For the POWS system in this work, Q is defined as:

$$Q = \frac{{p}_{{H}_{2}}}{{p}^{θ}} \cdot {( \frac{{p}_{{O}_{2}}}{{p}^{θ}} )}^{0.5}$$

Also, assuming the gas phase in the batch reactor follows the ideal gas law, then

$${p}_{{H}_{2}} V = {n}_{{H}_{2}} RT$$

$${p}_{{H}_{2}} = 2 {p}_{{O}_{2}}$$

Clearly, the changing partial pressures of H₂ and O₂ result in the changing Q and ΔᵣGₘ, which are summarised in Table 5. Also, the η_{STH} can be calculated using the free energy value at each given reaction time by the following equation:

$${η}_{STH} = \frac{{n}_{hydrogen} \times {Δ}_{r} {G}_{m} ( T , p )}{{P}_{solar} \times S \times t} \times 100 \%$$

Here n_{hydrogen} is the molar amount of the produced H₂; ΔᵣGₘ (T, p) is the Gibbs free energy at a given temperature and pressure; Pₛₒₗₐᵣ is the power of 1 Sun (100 mW cm⁻², AM 1.5G); S is the illuminating area; t is the reaction time.

Finally, the time-averaged free energy and η_{STH} over the reaction time of 2 hours are given as follows:

$$Time - average {Δ}_{r} {G}_{m} ( 543 K ) = 185.4 \pm 4.2 kJ {mol}^{- 1}$$

$$Time - average {η}_{STH} = 6.3 \pm 0.3 \%$$

The thermodynamic values at other conditions have also been evaluated accordingly.

### Supplementary Note 3

Evaluation of the quantum efficiency (QE). As described hereinbefore, the incident photons were corrected by subtracting the scattered and transmitted light from the incident light: there are two silica windows parallelly equipped on the both sides of the batch reactor, which are facing each other. Thus, the incident light was firstly measured using a light metre in the centre of the batch reactor; and then the scattered and transmitted light was also measured outside the opposite window when the reaction suspension is present. Subsequently, the light coming out of reactor was subtracted from the incident light, and the absorbed light energy was calculated.

According to the time-averaged free energy shown in Table 5, the thermodynamically required potential to drive the reaction could be calculated by:

$${Δ}_{r} {G}_{m} = - nFE$$

Here ΔᵣGₘ is the Gibbs free energy at a given condition; F is the Faraday constant; E is the potential required for the POWS reaction.

According to the analysis of the energy conversion limit of the solar conversion systems by Shockley and Queisser (which is later known as the Shockley-Queisser limit),²⁷ there is always a part of the photon energy that cannot do useful work, thus, the energy required to drive the reaction in practice must exceed the basic thermodynamic requirement. An energy barrier of 62.7 kJ mol⁻¹ was identified, in addition to the minimum thermodynamic requirement of this reaction in the system described herein, which is corresponding to a voltage of ca. 325 mV, which agrees with the evaluations by Ross and Bolton.^{28,29} A similar case has been reported previously.³⁰ Thus, the threshold wavelength λₜ which is just capable of driving the reaction can be calculated based on the equation:^{29,31}

$${λ}_{t} = \frac{hc}{\frac{{Δ}_{r} {G}_{m}}{n} + {U}_{loss}}$$

Here h is Planck's constant; c is the speed of light; n is the number of electrons transferred in the balanced redox reaction; Uₗₒₛₛ is the unused energy per photon.

The result is ca. 960 nm, which means only the photons with a wavelength shorter than 960 nm can drive the POWS reaction under the experimental conditions used herein. According to UV-vis DRS characterisations and Tauc plot analysis, the morphology-controlled N—TiO₂ in this work exhibits an absorption edge of ca. 873 nm, which is able to drive the POWS reaction in the conditions used herein.

Then the PC-QE calculations have been carried out. During the QE measurements, the light irradiation was provided by a Xe arc lamp and the wavelength was controlled by using different bandpass filters. The power of the lamp was tuned for each filter so that the light intensity was maintained at 100 mW cm⁻² in the centre of the reactor for all the measurements, determined by a light metre. The produced H₂ and O₂ were then measured by GC. Therefore, the number of photons and H₂ molecules can be calculated separately, as shown in Table 8. It should be clarified the PC-QE only evaluates the numbers of photons that are converted to H₂ molecules, instead of the energy stored in H₂. Then the PC-QE was calculated using Eq. S1.

For the calculation of the PT-QE, firstly, the photothermal conversion has been measured during the QE tests at each given wavelength following the protocol demonstrated hereinbefore, and the measured thermal energy values and the total energy conversion efficiencies are shown in Table 8. Subsequently, as what has been done for the η_{STH,PT} (Supplementary Note 1), the additional hydrogen evolution was evaluated based on a steam-turbine generator-water electrolysis system, using 40% and 72% as the efficiency for each process, respectively.²³⁻²⁶ Thus, the additional hydrogen evolution amount and the H₂ molecule numbers can be calculated likewise. Then, the PT-QE could also be calculated using Eq. S1. The combined QE (CQE) is the sum of PC-QE and PT-QE. All these QE values evaluated at different wavelengths are shown in Table 7.

### 2. Integrated Photocatalytic-Photothermal Water Splitting System

Herein, the STH conversion efficiency of the photocatalytic (PC) reaction has been defined as η_{STH,PC}, the photothermal (PT) conversion efficiency has been defined as η_{Thermal}, and the additional STH conversion efficiency of the PT-turbine-electrolysis process has been defined as η_{STH,PT} (FIG. 19b). Consequently, the total solar energy conversion efficiency (ηₛₒₗₐᵣ) and the overall STH conversion efficiency (η_{STH,overall}) can be calculated as follows:

$${η}_{Solar} = {η}_{STH , PC} + {η}_{Thermal} \qquad Equation 3$$

$${η}_{STH , overall} = {η}_{STH , PC} + {η}_{STH , PT} \qquad Equation 4$$

Herein, the PT conversion in the POWS reaction on a morphology-controlled N-doped TiO₂ (N—TiO₂) photocatalyst at elevated temperatures under the AM 1.5G simulated solar irradiation was investigated. Apart from a η_{STH} of 10.5±0.5%, it is demonstrated that 51.3±2.4% of solar energy can be converted to thermal energy via the POWS reaction in natural seawater. Using an infrared (IR) absorber, Cs_{0.33}WO₃, the IR that cannot drive the POWS reaction directly was captured, and converted it into heat, which leads to a ηₛₒₗₐᵣ of 92.9±3.4% and a η_{STH,overall} of 34.0±1.2% at 270° C. Moreover, this integrated PC-PT system enables a QE of more than 100% at 385-440 nm.

The N—TiO₂ nanocrystals were prepared using a hydrothermal method followed by a high-temperature NH₃ treatment.^{11,20} The X-ray powder diffraction (XRD) patterns indicate the successful synthesis of the anatase TiO₂ phase, and no phase transition can be observed after the ammonia treatment (FIG. 19c). X-ray photoelectron spectroscopy (XPS) confirms the inclusion of N atoms at the substitutional sites in the surface and sub-surface regions, showing the major signal at a binding energy of 396.0 eV (FIG. 19d). UV-Visible diffuse reflectance spectroscopy (UV-Vis DRS) was used to investigate the absorption of N—TiO₂, which suggests the greatly extended absorption range after N-doping. As a result, the N—TiO₂ gives a black colour (FIG. 19e). The Tauc plots are then investigated to estimate the bandgap energies of the TiO₂-based materials (FIG. 20c). High angle annular dark field scanning transmission electron microscopy (HAADF-STEM) shows a well-controlled morphology of the N—TiO₂ nanocrystals, and the high-resolution images suggest the lattice fringes with d-spacings of 0.237 and 0.352 nm, indicating the exposure of the (001) and (101) crystallographic facets, respectively (FIGS. 19f-19i). First-principles DFT calculations were engaged to understand the materials, and different supercells were constructed to simulate the pristine anatase TiO₂ and the N—TiO₂ (FIG. 20d). The calculated total density of states (DOS) shows that the defect states are introduced into the bandgap near the Fermi level after N-doping, which mainly consists of the N 2p orbitals. Also, it appears to show a wide defect energy band extended to the valence band (VB) rather than the localised energy states at a higher N-doping level, which also accounts for the enhanced visible light absorption.

It should be noted that the sluggish surface Vₒ regeneration is understood as the rate determining step in the metal-oxide-catalysed POWS systems at ambient conditions. Therefore, when the surface Vₒ regeneration is greatly facilitated at elevated temperatures, other effects could be investigated, which cannot be achieved at the ambient conditions. The POWS reported herein has been evaluated at elevated temperatures ranging from 200 to 300° C. Different noble metals were deposited on the N—TiO₂ nanocrystals respectively as the H₂ evolution co-catalyst via a photo-deposition method, among which Pt showed the most substantial effect (FIG. 21a). Control experiments and isotopic studies were carried out to confirm that H₂ and O₂ were indeed produced from the POWS reaction (FIG. 21b).

The PT conversion was then evaluated by monitoring the heating process of the POWS activity test on the Pt/N—TiO₂ (FIG. 18a). Control experiments were carried out in pure water, which did not show any H₂ evolution at 270° C. As shown in FIG. 22a, the required energy input for the Pt/N—TiO₂ suspension to maintain the reaction temperature of 270° C. is clearly lower than that for pure water, which indicates that the Pt/N—TiO₂ photocatalyst exhibits a substantial PT effect under the simulated solar irradiation, converting a part of solar energy into heat, as illustrated in FIG. 19a. Quantitative analysis has been carried out to calculate the η_{Thermal} (Supplementary Note 1). The POWS activity does not rise proportionally with the increasing temperature, instead, it peaks at around 270° C., giving a η_{STH},PC of 6.3±0.3%, and then declines on further temperature increase (FIG. 22b). Time-resolved photoluminescence (TRPL) spectroscopy was engaged to investigate the excitonic lifetime of the N—TiO₂ photocatalyst at different pH at room temperature to mimic the high-temperature conditions. As shown in FIGS. 22c and 22d, the fastest recombination took place at pH=7, and the exciton lifetimes apparently increased with a higher concentration of H⁺ or OH⁻. Clearly, an LEF originates from the adsorbed H⁺ or/and OH⁻ ions on the surface, which can attract the counter-charged electron or hole species, hence suppressing the recombination rate and enhancing the POWS activity. As a result, the photocatalytic activity follows the same trend as the ionic dissociation of water in response to the temperature change.

On the other hand, the η_{Thermal} showed an opposite trend with the reaction temperature compared to that of η_{STH,PC} (FIG. 22b), while the total solar conversion exhibits a similar value of ca. 61% across the studied temperature range. The collected thermal energy could contribute to additional H₂ evolution with the help of a steam turbine generator and the water electrolysis. Subsequently, the efficiency of this further conversion to H₂ has also been calculated. Using the literature for the achievable efficiency values of steam turbine generators and PEM electrolysers, the values of 40% and 72% are used herein in the calculations, respectively.²³⁻²⁶ Consequently, the overall STH efficiency, η_{STH,overall}, is shown in FIG. 22e. Clearly, the η_{STH,overall} reaches its maximum at 270° C., giving an efficiency of 22.1±1.0%, which outperforms the conventional POWS systems greatly (Table 4 and Supplementary Note 1). The Gibbs free energy of the POWS reaction in this work has been corrected for the actual operating conditions (Supplementary Note 2 and Table 5).^{10,32}

TABLE 4
Energy conversion efficiencies for the PC-PT system in this work over
the 1 wt. % Pt/N—TiO₂ at different reaction temperatures. ^{†}

| Temperature | | | | | |
|---|---|---|---|---|---|
| (° C.) | η_{STH, PC} | η_{Thermal} | η_{Solar} | η_{STH, PT} | η_{STH, overall} |
| 210 | 2.1 ± 0.2 | 58.8 ± 2.5 | 60.9 ± 2.7 | 16.9 ± 0.7 | 19.0 ± 0.9 |
| 230 | 2.8 ± 0.3 | 58.3 ± 2.2 | 61.1 ± 2.5 | 16.8 ± 0.6 | 19.6 ± 0.9 |
| 250 | 4.2 ± 0.3 | 57.1 ± 2.6 | 61.3 ± 2.9 | 16.4 ± 0.7 | 20.6 ± 1.0 |
| 270 | 6.3 ± 0.3 | 54.9 ± 2.5 | 61.2 ± 2.8 | 15.8 ± 0.7 | 22.1 ± 1.0 |
| 270 ^{‡} | 10.5 ± 0.5 | 51.3 ± 2.4 | 61.8 ± 2.9 | 14.8 ± 0.7 | 25.3 ± 1.3 |
| 270 ^{§} | 10.2 ± 0.3 | 82.7 ± 3.1 | 92.9 ± 3.4 | 23.8 ± 0.9 | 34.0 ± 1.2 |
| 290 | 3.1 ± 0.3 | 57.8 ± 2.8 | 60.9 ± 3.1 | 16.6 ± 0.8 | 19.7 ± 1.1 |

† The detailed calculations of the energy efficiency values in this table are shown in the Supplementary Notes.
^{‡} This performance was evaluated in natural seawater instead of pure water.
^{§} This performance was evaluated in the presence of Cs_{0.33}WO₃ as an IR absorber.

TABLE 5
Time-dependent partial pressure, free energy and STH conversion
efficiency for a 2-hour POWS reaction at 270° C. on 1 wt. % Pt/N—TiO₂
photocatalyst under simulated solar irradiation.

| Reaction | | | Free energy | STH |
|---|---|---|---|---|
| time (h) | p_{H}_{₂} (kPa) ^{†} | pₒ_{₂} (kPa) ^{†} | (kJ mol⁻¹) ^{b} | (%)^{‡} |
| 0.5 | 10.7 | 5.2 | 179.9 | 6.0 |
| 1 | 21.7 | 10.6 | 184.7 | 6.3 |
| 1.5 | 33.2 | 16.6 | 187.6 | 6.5 |
| 2 | 43.8 | 21.8 | 189.5 | 6.6 |
| Time-average | / | / | 185.4 ± 4.2 | 6.3 ± 0.3 |

† The amounts of produced H₂ and O₂ were quantitatively analysed by GC equipped with TCD, and the partial pressures are calculated using the ideal gas law.
^{‡}Detailed calculations of the free energy at different temperatures and partial pressures are shown in Supplementary Note 2, and the STH conversion efficiency is calculated based on the free energy at each given condition. Further discussions can be found in Supplementary Note 2.

It should be noted that for a solar conversion system, the absorbed solar energy can be converted to chemicals (photocatalytic conversion), heat (photothermal conversion), or light (photoluminescence, PL). In the PC-PT system at elevated temperatures described herein, both the PC and the PT conversion could contribute to the H₂ evolution at last, but the PL will not, which means the PL should be suppressed for a more efficient solar conversion of this system. It has been reported that the defects, including the doped N atoms and the introduced Vos, can act as the trapping sites for the charge carriers, therefore prolonging the lifetime of the photogenerated charge carriers, and suppressing the radiative recombination³³⁻³⁵. N—TiO₂ materials with lower N-doping concentrations, denoted as Low-N—TiO₂ and Medium-N—TiO₂, respectively (Table 6), were therefore investigated. The ηₛₒₗₐᵣ shows a positive correlation with the N-doping concentration, and then the PL spectra of the TiO₂-based materials have also been obtained (FIG. 23). As the N-doping concentration increases, the PL intensity drops, because the radiative recombination is greatly suppressed due to the increased concentration of defects, and the charge recombination takes the phonon-assisted non-radiative pathways instead³⁶⁻³⁹. It has been reported that the PL of the indirect-bandgap anatase TiO₂ is typically very low, giving an emission quantum yield of 1.0-10%^{40,41}. Thus, it can be deduced that the emission quantum yield of the N—TiO₂ is negligible in this case (<1%), given that the emission peak area of the N—TiO₂ sample is only 6.2% of that for the pure TiO₂. By careful analysis of the AM 1.5G spectrum and the UV-Vis DRS, it is shown that the N—TiO₂ is able to absorb 62.5% of the energy in solar spectrum (FIG. 20e). In addition, it has been shown that the ηₛₒₗₐᵣ of N—TiO₂ at 270° C. is 61.2±2.8%, which demonstrates a nearly complete conversion (˜97.9%) of the absorbed energy within experimental errors. With regard to the N—TiO₂ with lower N-doping concentrations, they exhibit a lower useful conversion of solar energy in the system described herein, due to their poorer visible light absorption and the significant PL emission. As a result, the ηₛₒₗₐᵣ of the Pt/Low-N—TiO₂ catalyst is only 15.5% (Table 6). Furthermore, both the Pt/N—TiO₂ and the N—TiO₂ photocatalysts demonstrate stable H₂ and O₂ production in a stoichiometric ratio of 2:1 at 270° C. under the simulated solar irradiation (FIG. 22f). All the efficiency values demonstrated in this work have also been repeated in another experimental set-up to reassure the evaluations and reduce the experimental errors (FIG. 18b).

TABLE 6
Characterisations and POWS performance of the N—TiO₂
with different N-doping concentrations. ^{†}

| | N-doping | Absorption | Solar | η_{Solar} |
|---|---|---|---|---|
| Materials | (wt. %) | edge (nm) | absorption (%) | (%) |
| Low-N—TiO₂ | 1.3 | 530 | 19.7 | 15.5 |
| Medium-N—TiO₂ | 2.7 | 697 | 43.7 | 38.3 |
| N—TiO₂ | 5.6 | 873 | 62.5 | 61.2 |

^{†} N-doping concentrations are obtained from XPS spectra. Absorption edges are evaluated from the UV-vis DRS. Solar absorption percentages are calculated based on the ASTM G173-03 reference solar spectrum shown in FIG. 20e. The POWS performance has been evaluated at 270° C.

Subsequently, QE of the PC and the PT conversions was studied. As shown in FIG. 24a, very high PC-QE of 77.3% was obtained at 385 nm at 270° C. over the Pt/N—TiO₂ (Table 7). Generally, the PC-QE decreases with the increasing wavelength, which can be attributed to the wavelength-dependent η_{harvesting} that dramatically drops at longer wavelengths. The longer-wavelength photons cannot efficiently contribute to the exciton generation, but excite the localised transitions instead, resulting in the decrease of PC-QE. Consequently, a relatively low internal QE of 4.5% is observed in the NIR regime at 850 nm (FIG. 24a). It is noteworthy that the η_{EE} at short wavelengths are relatively low, giving only 29.8% at 385 nm, while it could reach 65.9% at 850 nm. Therefore, even though many have reported high QE values in the UV regime⁴², it does not greatly contribute to the overall solar energy conversion, given that UV only accounts for 4% in the solar spectrum. Moreover, as illustrated before, the PT energy is stored in the superheated steam as high-quality heat, which could further contribute to the extra H₂ evolution. Therefore, the PT conversion has been evaluated at different wavelengths. The total energy conversion efficiency of the PC and the PT processes at each wavelength gives a value of more than 96%, indicating that only a negligible amount of the absorbed energy is wasted as PL emission (Table 8). Subsequently, the PT-QE and the combined QE (CQE) have been calculated, as shown in Table 7, FIG. 24b, and Supplementary Note 3. Excitingly, the PC-PT water splitting system that is demonstrated in this work enables a CQE of more than 100% at 385 nm and 440 nm. Although the QE of higher than 100% has been reported on solar cells via the multiple exciton generation mechanism⁴³, It is believed that the work described herein demonstrates the first particulate overall water splitting system which could achieve a combined QE of 148.9% using an inexpensive TiO₂-based photocatalyst.

TABLE 7
Quantum efficiencies of 1 wt. % Pt/N—TiO₂ evaluated
at 270° C. at different wavelengths for the PC-PT
system demonstrated in this work.

| Wavelength | | | | |
|---|---|---|---|---|
| (nm) | PC-QE (f₁) ^{†} | | PT-QE (f₂) ^{‡} | Combined QE |
| 385 | 77.3 ± 2.4 | (0.52) | 71.6 ± 3.8 (0.48) | 148.9 ± 6.2 |
| 437 | 50.2 ± 1.9 | (0.43) | 66.9 ± 3.2 (0.57) | 117.1 ± 5.1 |
| 575 | 21.8 ± 2.3 | (0.28) | 56.5 ± 2.9 (0.72) | 78.3 ± 5.2 |
| 650 | 9.8 ± 1.4 | (0.16) | 52.3 ± 2.5 (0.84) | 62.2 ± 3.9 |
| 750 | 7.2 ± 1.6 | (0.14) | 45.7 ± 2.1 (0.86) | 52.9 ± 3.7 |
| 850 | 4.5 ± 0.9 | (0.10) | 40.9 ± 1.8 (0.90) | 45.4 ± 2.7 |

^{†} f₁ and f₂ shown in the brackets represent the fractions of QE and additional QE in the combined QE, respectively. (i.e., f₁ = PC-QE/combined QE; f₂ = PT-QE/combined QE)
^{‡} The PT-QE is calculated from the photothermally converted energy, assuming that such energy is used in steam turbine generator for electricity generation, and then the electricity is used on an electrolyser for water electrolysis. Overall, such photothermal energy is converted to H₂. Detailed calculation is shown in Supplementary Note 3. The power of the Xe lamp was tuned for each filter so that the light intensity was maintained at 100 mW cm⁻² in the centre of the reactor for all the measurements, determined by a light metre.

TABLE 8
Measured H₂ evolution and photothermal energy of the
QE evaluations at different wavelengths at 270° C.

| | | | PT | Conversion of |
|---|---|---|---|---|
| Wavelength | Number of | n_{hydrogen} | energy | the absorbed |
| (nm) | photons (×10²¹) | (μmol) | (J) | energy (%) ^{†} |
| 385 | 1.09 | 703.1 | 419.1 | 97.2 |
| 437 | 1.25 | 521.8 | 447.6 | 96.3 |
| 575 | 1.63 | 295.5 | 494.2 | 97.1 |
| 650 | 1.85 | 150.9 | 517.1 | 96.4 |
| 750 | 2.13 | 127.7 | 520.8 | 96.3 |
| 850 | 2.42 | 90.8 | 528.9 | 96.6 |

^{†} Conversion of absorption indicates the fraction of the absorbed photon energy that is converted in the PC-PT system and stored in H₂ and heat. The rest of the energy may be scattered or released as photoluminescence. The power of the Xe lamp was tuned for each filter so that the light intensity was maintained at 100 mW cm⁻² in the centre of the reactor for all the measurements, determined by a light metre.

With regard to the future application of this system, the use of seawater instead of pure water is more favourable, because more than 90% of the water resource on the earth surface is stored in seas and oceans⁴⁴, and the water purification largely adds up to the overall capital costs of this technology⁴⁵. Therefore, the performance of this PC-PT integrated system has been evaluated using natural seawater. As shown in FIGS. 24e and 24f, a more efficient PC conversion is observed in natural seawater, presumably due to the LEF effect enhanced by the high concentration of the ionic species in seawater, giving the improved η_{STH,PC} and η_{STH,overall} of 10.5% and 25.3%, respectively. In addition, it should be clarified that the extensive IR light in solar spectrum could exert an additional PT conversion when an appropriate IR absorber is present. Such IR effect has not been considered in the previous discussion, since the Pt/N—TiO₂ suspension does not show much IR absorption. Therefore, Cs_{0.33}WO₃ nanoparticles were used to harness the IR in solar spectrum. Cs_{0.33}WO₃ is an IR absorber, which is transparent in the visible light regime^{46,47}. The thermal effect introduced by the IR has then been investigated. As a result, an improved ηₛₒₗₐᵣ of 92.9% and η_{STH,overall} of 34.0% are obtained on the Pt/N—TiO₂ and Cs_{0.33}WO₃ suspended in natural seawater at 270° C. (Table 4).

The versatility of this PC-PT system at elevated temperatures is then demonstrated on other semiconductor materials, including Ta₃N₅ and BaTaO₂N. As shown in FIG. 24c, the PC and PT conversions are observed for all the three photocatalysts, with the N—TiO₂ showing the highest ηₛₒₗₐᵣ and Ta₃N₅ exhibiting the poorest performance (Table 9)

TABLE 9
Performance of different materials in the PC-PT system in this
work at 270° C. under 1 Sun irradiation. ^{†}

| | Bandgap | Solar absorption | |
|---|---|---|---|
| Catalyst | (eV) | (%) | η_{Solar} |
| N—TiO₂ | 1.42 | 64.9 | 61.2 ± 2.8 |
| BaTaO₂N | 1.8 | 46.2 | 39.5 ± 2.3 |
| Ta₃N₅ | 2.1 | 32.3 | 23.9 ± 2.1 |

^{†} The calculation of the efficiencies is the same as that is described in Supplementary Notes. Bandgap energies of BaTaO₂N and Ta₃N₅ are obtained from literature. Solar absorption is then calculated based on the bandgap energy using ASTM G173-03 reference.

In summary, the POWS reaction at elevated temperatures, as well as the PC and the PT conversions, have been systematically investigated. Taking the N—TiO₂ as an example, it has been demonstrated that the η_{STH} is a function of the reaction temperature, reaching its maximum at 270° C. A remarkable QE is observed for the direct PC conversion from the UV to the NIR regime. Apart from a STH conversion of 10.2%, it is demonstrated that 82.7% of the solar energy can be converted to heat at 270° C. in a suspension of the Pt/N—TiO₂ photocatalyst and the Cs_{0.33}WO₃ nanoparticles in natural seawater. As a result, a ηₛₒₗₐᵣ of 92.9% has been achieved in this work, which represents a nearly complete conversion of solar energy. Unlike the conventional POWS systems at ambient conditions, in this POWS system at elevated temperatures, the superheated steam with high pressure could be subsequently fed into a steam turbine generator, followed by water electrolysis, therefore the high-quality heat stored in steam could finally contribute to additional H₂ evolution. Taking this into account, the total STH conversion efficiency, η_{STH,overall}, could be 34.0%, which outperforms the other solar conversion systems (Table 10). Moreover, a combined QE exceeding 100% can be achieved in this system. Ta₃N₅ and BaTaO₂N have been studied to demonstrate the applicability of this PC-PT water splitting system at elevated temperatures.

TABLE 10
Device-to-device comparison of the overall water splitting performance
in this work with the related systems reported in literature.

| | | Solar conversion | Overall STH | |
|---|---|---|---|---|
| Device type | Catalyst | (%) | (%) † | Ref. |
| Particulate | Pt/N—TiO2 (pure water) | 61.2 ± 2.8 | 22.1 ± 1.0 | This |
| POWS | | | | work |
| Particulate | Pt/N—TiO2 (seawater) | 61.8 ± 2.9 | 25.3 ± 1.3 | This |
| POWS | | | | work |
| Particulate | Pt/N—TiO2 and | 92.9 ± 3.4 | 34.0 ± 1.2 | This |
| POWS | Cs0.33WO3 (seawater) | | | work |
| Particulate | Rh/Cr2O3/CoOOH-loaded | 0.65 | 0.65 | ⁴² |
| POWS | Al-doped SrTiO3 | | | |
| Particulate | SrTiO3:La, Rh and | 1.1 | 1.1 | ⁵ |
| POWS | BiVO4:Mo | | | |
| PV-E | CH3NH3Pbl3—NiFe LDH | 12.3 | 12.3 | ⁴⁸ |
| PV-E | Si PV-Fe:Co2Mo3O8 | 15.1 | 15.1 | ⁴⁹ |
| PV-E | InGaP/GaAs/GaInNAsSb- | 30 | 30 | ⁵⁰ |
| | PEM electrolyser | | | |
| PEC | GaInP-GaInAs | 14 | 14 | ⁵¹ |
| PEC | InGaP/GaAs | 9 | 9 | ⁵² |
| PEC | Ba—Ta3N5 | 1.5 | 1.5 | ⁵³ |
| STEG ‡ | Bi2Te3 and CoSb3 | 9.6 | 6.9 | ⁵⁴ |
| Hybrid PV/T †† | PV panel | 85.1 | 26.8 | ⁵⁵ |
| PT-turbine- | Pt/N—TiO2 and | 92.9 | 26.8 | This |
| electrolysis § | Cs0.33WO3 (seawater) | | | work |

† The solar conversion efficiency and the overall STH conversion efficiency in this work are evaluated with the AM 1.5 G simulated solar irradiation (1 Sun) at 270° C., which are compared with the competing solar conversion devices reported in literature.
‡ This solar thermoelectric generator (STEG) converts solar energy to electricity with an energy conversion efficiency of 9.6%. Then the STH efficiency is evaluated, assuming that the electricity is converted to H₂ via an electrolyser with an energy efficiency of 72%.
†† This hybrid system converts solar energy to electricity (5.4%) and heat (79.7%) simultaneously. It is assumed that the produced electricity and heat are finally converted to H₂ via steam turbine and/or electrolyser, and the STH efficiency is calculated accordingly.
§ This hypothetic photothermal-turbine-electrolysis system is a special case of the integrated PC-PT system demonstrated in this work, in which no direct photocatalytic conversion takes place, and all the absorbed solar energy dissipates as heat. The heat is then converted to H₂ via a steam turbine and electrolysis as demonstrated herein. The theoretical energy conversion efficiencies are therefore evaluated.

While specific embodiments of the invention have been described herein for the purpose of reference and illustration, various modifications will be apparent to a person skilled in the art without departing from the scope of the invention as defined by the appended claims.

### REFERENCES

1. Zhou, G. et al. Photoinduced semiconductor-metal transition in ultrathin troilite FeS nanosheets to trigger efficient hydrogen evolution. Nature Communications 10, 399 (2019).
2. Li, Q. et al. Highly efficient visible-light-driven photocatalytic hydrogen production of CdS-cluster-decorated graphene nanosheets. J Am Chem Soc 133, 10878-10884 (2011).
3. Chen, X., Shen, S., Guo, L. & Mao, S. S. Semiconductor-based photocatalytic hydrogen generation. Chemical Reviews 110, 6503-6570 (2010).
4. Hisatomi, T. & Domen, K. Reaction systems for solar hydrogen production via water splitting with particulate semiconductor photocatalysts. Nature Catalysis 2, 387-399 (2019).
5. Wang, Q. et al. Scalable water splitting on particulate photocatalyst sheets with a solar-to-hydrogen energy conversion efficiency exceeding 1%. Nature Materials 15, 611-615 (2016).
6. Liao, L. et al. Efficient solar water-splitting using a nanocrystalline CoO photocatalyst. Nature Nanotechnology 9, 69-73 (2014).
7. Tian, B. et al. Supported black phosphorus nanosheets as hydrogen-evolving photocatalyst achieving 5.4% energy conversion efficiency at 353 K. Nature Communications 9, 1397 (2018).
8. Wang, Q. & Domen, K. Particulate Photocatalysts for Light-Driven Water Splitting: Mechanisms, Challenges, and Design Strategies. Chemical Reviews 120, 919-985 (2020).
9. Peng, Y. K. et al. Engineering of Single Magnetic Particle Carrier for Living Brain Cell Imaging: A Tunable T1-/T2-/Dual-Modal Contrast Agent for Magnetic Resonance Imaging Application. Chemistry of Materials 29, 4411-4417 (2017).
10. Li, Y. et al. Local magnetic spin mismatch promoting photocatalytic overall water splitting with exceptional solar-to-hydrogen efficiency. Energy & Environmental Science 15, 265-277 (2022).
11. Li, Y. et al. Photocatalytic water splitting by N—TiO₂ on MgO (111) with exceptional quantum efficiencies at elevated temperatures. Nature Communications 10, 4421 (2019).
12. Gertman, I., Kress, N., Katsenelson, B. & Zavialov, P. Equations of state for the Dead Sea and Aral Sea: Searching for common approaches. IOLR report IOLR/12/2010 (2010).
13. Nissenbaum, A. The microbiology and biogeochemistry of the Dead Sea. Microbial Ecology 2, 139-161 (1975).
14. Whelan, J. A. & Petersen, C. A. Great Salt Lake, Utah: Chemical and Physical Variations of the Brine, Water-Year 1973. Utah Geol Mineral Surv, Water-Resour Bull 1966-1972 (1975) doi:10.34191/wrb-20.
15. Sun, M. G. & Ma, L. C. Potassium-rich brine deposit in Lop Nor basin, Xinjiang, China. Scientific Reports 8, 1-9 (2018).
16. Li, Y. et al. 2D photocatalysts with tuneable supports for enhanced photocatalytic water splitting. Materials Today 41, 34-43 (2020).
17. Li, Y. et al. Photocatalytic water splitting by N—TiO₂ on MgO (111) with exceptional quantum efficiencies at elevated temperatures. Nature Communications 10, 4421 (2019).
18. Li, Y. & Tsang, S. C. E. Recent Progress and Strategies for Enhancing Photocatalytic Water Splitting. Materials Today Sustainability 9, 100032 (2020).
19. di Valentin, C., Pacchioni, G., Selloni, A., Livraghi, S. & Giamello, E. Characterization of paramagnetic species in N-doped TiO 2 powders by EPR spectroscopy and DFT calculations. Journal of Physical Chemistry B 109, 11414-11419 (2005).
20. Peng, Y.-K. et al. Mapping surface-modified titania nanoparticles with implications for activity and facet control. Nature Communications 8, 675 (2017).
21. Meng, A., Zhang, J., Xu, D., Cheng, B. & Yu, J. Enhanced photocatalytic H₂-production activity of anatase TiO₂ nanosheet by selectively depositing dual-cocatalysts on (101) and (001) facets. Applied Catalysis B: Environmental 198, 286-294 (2016).
22. Zhang, H. et al. Facet-Dependent Interfacial Charge Transfer in Fe(III)-Grafted TiO2 Nanostructures Activated by Visible Light. ACS Catalysis 8, 9399-9407 (2018).
23. Joseph Omosanya, A., Titilayo Akinlabi, E. & Olusegun Okeniyi, J. Overview for Improving Steam Turbine Power Generation Efficiency. Journal of Physics: Conference Series 1378, (2019).
24. Kumar Dubey, K. & Mishra, R. S. Thermo-statistical study of sustainable refrigeration system for stack flow heat recovery of combined gas turbine-steam turbine power generation. Materials Today: Proceedings 43, 74-83 (2020).
25. Chi, J. & Yu, H. Water electrolysis based on renewable energy for hydrogen production. Chinese Journal of Catalysis 39, 390-394 (2018).
26. BEIS. Combined heat and power—Technologies. Combined Heat and Power (CHP) developers guides (2021).
27. Shockley, W. & Queisser, H. J. Detailed balance limit of efficiency of p-n junction solar cells. Journal of Applied Physics 32, 510-519 (1961).
28. Ross, R. T. & Hsiao, T. L. Limits on the yield of photochemical solar energy conversion. Journal of Applied Physics 48, 4783-4785 (1977).
29. Bolton, J. R., Stricklert, S. J. & Connolly, J. S. Limiting and realizable efficiencies of Solar Photolysis of Water. Nature 316, 495-500 (1985).
30. Foo, C. et al. Characterisation of oxygen defects and nitrogen impurities in TiO2 photocatalysts using variable-temperature X-ray powder diffraction. Nature Communications 12, 661 (2021).
31. Bolton, J. R. Solar fuels. Science (1979) 202, 705-711 (1978).
32. Wang, Z. et al. Efficiency Accreditation and Testing Protocols for Particulate Photocatalysts toward Solar Fuel Production. Joule 5, 344-359 (2021).
33. Liu, K. I., Su, C. Y. & Perng, T. P. Highly porous N-doped TiO2 hollow fibers with internal three-dimensional interconnected nanotubes for photocatalytic hydrogen production. RSC Advances 5, 88367-88374 (2015).
34. Lim, S. P., Pandikumar, A., Lim, H. N., Ramaraj, R. & Huang, N. M. Boosting photovoltaic performance of dye-sensitized solar cells using silver nanoparticle-decorated N,S—Co-doped-TiO2 photoanode. Scientific Reports 5, 11922 (2015).
35. Graciani, J., Álvarez, L. J., Rodriguez, J. A. & Sanz, J. F. N doping of rutile TiO2 (110) surface. A theoretical DFT study. Journal of Physical Chemistry C 112, 2624-2631 (2008).
36. Shu, Y., Fales, B. S., Peng, W. T. & Levine, B. G. Understanding Nonradiative Recombination through Defect-Induced Conical Intersections. Journal of Physical Chemistry Letters 8, 4091-4099 (2017).
37. Chu, W., Zheng, Q., Prezhdo, O. v., Zhao, J. & Saidi, W. A. Low-frequency lattice phonons in halide perovskites explain high defect tolerance toward electron-hole recombination. Science Advances 6, 7453-7467 (2020).
38. Li, Y. et al. The Auger process in multilayer WSe2 crystals. Nanoscale 10, 17585-17592 (2018).
39. Luo, D., Su, R., Zhang, W., Gong, Q. & Zhu, R. Minimizing non-radiative recombination losses in perovskite solar cells. Nature Reviews Materials 2019 5:1 5, 44-60 (2019).
40. Li, Y. et al. High photoluminescence quantum yield of TiO₂ nanocrystals prepared using an alcohothermal method. Luminescence 22, 540-545 (2007).
41. Kaniyankandy, S. & Ghosh, H. N. Efficient luminescence and photocatalytic behaviour in ultrafine TiO 2 particles synthesized by arrested precipitation. Journal of Materials Chemistry 19, 3523-3528 (2009).
42. Takata, T. et al. Photocatalytic water splitting with a quantum efficiency of almost unity. Nature 581, 411-414 (2020).
43. Semonin, O. E. et al. Peak External Photocurrent Quantum Efficiency Exceeding 100% via MEG in a Quantum Dot Solar Cell. Science (1979) 334, 1530-1534 (2011).
44. Jin, H. et al. Stable and Highly Efficient Hydrogen Evolution from Seawater Enabled by an Unsaturated Nickel Surface Nitride. Advanced Materials 33, 2007508 (2021).
45. Culp, T. E. et al. Nanoscale control of internal inhomogeneity enhances water transport in desalination membranes. Science (1979) 371, 72-75 (2021).
46. Chen, C. J. & Chen, D. H. Preparation and near-infrared photothermal conversion property of cesium tungsten oxide nanoparticles. Nanoscale Research Letters 8, 57 (2013).
47. Xu, Q. et al. Cs0.33WO3 as a high-performance transparent solar radiation shielding material for windows. Journal of Applied Physics 124, 193102 (2018).
48. Luo, J. et al. Water photolysis at 12.3% efficiency via perovskite photovoltaics and Earth-abundant catalysts. Science (1979) 345, 1593-1596 (2014).
49. Yi, X. et al. Cost-Efficient Photovoltaic-Water Electrolysis over Ultrathin Nanosheets of Cobalt/Iron-Molybdenum Oxides for Potential Large-Scale Hydrogen Production. Small 17, 2102222 (2021).
50. Jia, J. et al. Solar water splitting by photovoltaic-electrolysis with a solar-to-hydrogen efficiency over 30%. Nature Communications 7, 13237 (2016).
51. May, M. M., Lewerenz, H. J., Lackner, D., Dimroth, F. & Hannappel, T. Efficient direct solar-to-hydrogen conversion by in situ interface transformation of a tandem structure. Nature Communications 6, 8286 (2015).
52. Varadhan, P., Fu, H. C., Kao, Y. C., Horng, R. H. & He, J. H. An efficient and stable photoelectrochemical system with 9% solar-to-hydrogen conversion efficiency via InGaP/GaAs double junction. Nature Communications 10, 5282 (2019).
53. Li, Y. et al. Cobalt phosphate-modified barium-doped tantalum nitride nanorod photoanode with 1.5% solar energy conversion efficiency. Nature Communications 4, 2566 (2013).
54. Kraemer, D. et al. Concentrating solar thermoelectric generators with a peak efficiency of 7.4%. Nature Energy 1, 16153 (2016).
55. Codd, D. S. et al. Solar Cogeneration of Electricity with High-Temperature Process Heat. Cell Reports Physical Science 1, 100135 (2020).

1. A process for the photocatalytic splitting of water, the process comprising the step of:
a) contacting a photocatalyst with an aqueous solution of at least one neutral salt; wherein step a) is conducted under the application of light having a wavelength of 350-1000 nm and at a temperature of 200-400° C.

2. (canceled)

3. The process of claim 1, wherein the aqueous solution of the at least one neutral salt has an ionic strength of ≥0.1 mol L⁻¹.

4. The process of claim 1, wherein the aqueous solution of the at least one neutral salt has an ionic strength of ≥0.5 mol L⁻¹.

5. (canceled)

6. The process of claim 1, wherein the concentration of the at least one neutral salt within the aqueous solution is ≥0.1 mol L⁻¹.

7. The process of claim 1, wherein the concentration of the at least one neutral salt within the aqueous solution is ≥0.5 mol L⁻¹.

8. The process of claim 1, wherein the at least one neutral salt is an inorganic salt, optionally wherein the at least one neutral salt is selected from the group consisting of NaCl, MgCl₂, CaCl₂, NaSO₄ and Na₃PO₄; or the at least one neutral salt is NaCl.

9. (canceled)

10. The process of claim 1, wherein the aqueous solution of the at least one neutral salt is naturally occurring; and/or the at least one neutral salt is seawater or salt lake water.

11. (canceled)

12. The process of claim 1, wherein the aqueous solution of the at least one neutral salt has a pH of 6-9.

13. (canceled)

14. The process of claim 1, wherein the photocatalyst is a metal oxide photocatalyst, a nitrogen-doped metal oxide photocatalyst, optionally (nitrogen-doped titanium dioxide, a 2-dimensional transition metal dichalcogenide photocatalyst, an oxynitride perovskite photocatalyst or a metal nitride photocatalyst.

15. The process of claim 14, wherein the photocatalyst is a metal oxide photocatalyst comprising a metal oxide selected from titanium dioxide, tantalum pentoxide and zinc oxide, wherein the metal oxide photocatalyst optionally comprises 0.05-5.0 wt. % of at least one transition metal reduction co-catalyst;
optionally wherein the transition metal reduction co-catalyst is selected from the group consisting of Au, Ag, Ni, Pd, Pt, Co, Ir, Ru, Rh, Tc, Re, and Os.

16. The process of claim 14, wherein the photocatalyst is a 2-dimensional transition metal dichalcogenide photocatalyst of the formula MX₂, where M is Mo or W and X is S, Se or Te, optionally wherein the 2-dimensional transition metal dichalcogenide photocatalyst comprises 0.05-5.0 wt. % of at least one transition metal reduction co-catalyst;
optionally wherein the transition metal reduction co-catalyst is selected from the group consisting of Au, Ag, Ni, Pd, Pt, Co, Ir, Ru, Rh, Tc, Re, and Os.

17. (canceled)

18. The process of claim 14, wherein the photocatalyst is (i) a nitrogen-doped titanium dioxide photocatalyst comprising 0.05-5.0 wt. % of at least one transition metal reduction co-catalyst, wherein the at least one transition metal reduction co-catalyst is Au; or (ii) a 2-dimensional transition metal dichalcogenide photocatalyst that is MoS₂ having a thickness of 0.4-0.9 nm, optionally (a MoS₂ monolayer and comprising 0.05-5.0 wt. % of at least one transition metal reduction co-catalyst, wherein the at least one transition metal reduction co-catalyst is Ru.

19. The process of claim 1, wherein the photocatalyst is supported on a polar faceted metal oxide support.

20. The process of claim 1, wherein step a) is conducted at a temperature of 240-300° C.

21. The process of claim 1, wherein step a) is conducted at a temperature of 250-290° C. (255-285° C.).

22. The process according to claim 1, wherein the light having a wavelength of 350-1000 nm in step a) is provided as solar energy.

23. The process according to claim 1, wherein solar energy is used as both a light source and a heat source during step a), optionally wherein solar energy is concentered using a solar concentrator during step a).

24. The process of claim 1, wherein the photocatalyst further comprises magnetic particles, optionally (magnetic nanoparticles and step a) is carried out under application of an external magnetic field.

25. The process of claim 24, wherein the magnetic particles are paramagnetic or superparamagnetic Fe₃O₄ nanoparticles having a mean particle size of 2-20 nm.

26. The process of claim 1, wherein the photocatalyst is provided in the form of a powder, particles, pellets, a film or as a fixed bed.
